(19) United States
(12) Patent Application Publication
(10) Pub. No.: US 2023/0356728 A1
(43) Pub. Date: Nov. 9, 2023

(54) USING GESTURES TO CONTROL MACHINES FOR AUTONOMOUS SYSTEMS AND APPLICATIONS

(71) Applicant: NVIDIA Corporation, Santa Clara, CA (US)

(72) Inventors: Anshul Jain, Santa Clara, CA (US); Ratin Kumar, Cupertino, CA (US); Feng Hu, Santa Clara, CA (US); Niranjan Avadhanam, Santa Clara, CA (US); Atousa Torabi, Santa Clara, CA (US); Hairong Jiang, Campbell, CA (US); Ram Ganapathi, San Jose, CA (US); Taek Kim, San Jose, CA (US)

(21) Appl. No.: 18/144,651

(22) Filed: May 8, 2023

Related U.S. Application Data
(63) Continuation of application No. 16/363,648, filed on Mar. 25, 2019, now abandoned.
(60) Provisional application No. 62/742,923, filed on Oct. 8, 2018.
(60) Provisional application No. 62/648,358, filed on Mar. 26, 2018.

(51) Int. Cl. B60W 30/18; B60W 50/00; B60W 40/08; G06V 40/19; G05B 13/02; G05D 1/00; G06F 18/25; G06V 10/141; G06V 20/59

(52) U.S. Cl. CPC B60W 50/0098; B60W 30/18; B60W 40/08; G05B 13/027; G05D 1/0061; G06F 18/251; G06V 10/141; G06V 20/597; G06V 40/19; B60W 2040/0836; B60W 2540/26; H04N 23/71

(57) ABSTRACT

Approaches for an advanced AI-assisted vehicle can utilize an extensive suite of sensors inside and outside the vehicle, providing information to a computing platform running one or more neural networks. The neural networks can perform functions such as facial recognition, eye tracking, gesture recognition, head position, and gaze tracking to monitor the condition and safety of the driver and passengers. The system also identifies and tracks body pose and signals of people inside and outside the vehicle to understand their intent and actions. The system can track driver gaze to identify objects the driver might not see, such as cross-traffic and approaching cyclists. The system can provide notification of potential hazards, advice, and warnings. The system can also take corrective action, which may include controlling one or more vehicle subsystems, or when necessary, autonomously controlling the entire vehicle. The system can work with vehicle systems for enhanced analytics and recommendations.

### CROSS-REFERENCE TO RELATED APPLICATIONS

This application is a continuation of U.S. Pat. Application No. 16/363,648, filed Mar. 25, 2019, which claims priority to U.S. Provisional Pat. Application Serial No. 62/648,358, filed Mar. 26, 2018, as well as U.S. Provisional Pat. Application Serial No. 62/742,923, filed Oct. 8, 2018. Each of which is hereby incorporated herein by reference in its entirety.

### BACKGROUND

The task of designing a system to drive a vehicle autonomously without human supervision at a level of safety required for practical acceptance is tremendously difficult. Most of today’s advanced driver assistance systems (ADAS) are level 2 systems, including Tesla’s Autopilot, Cadillac’s Supercruise and Volvo’s Pilot Assist. Where level 1 vehicles control either speed or steering, vehicles at level 2 can control both simultaneously, and may include features such as lane centering. In these level 2 systems, the “autonomous mode” is limited to certain conditions and human drivers still must take control when driving over any terrain more complicated than highways or clearly marked roads.

Conventional ADAS technology can detect some objects, do basic object classification, alert the driver of hazardous road conditions, and in some cases, slow or stop the vehicle. This level of ADAS is limited to basic applications like blind spot monitoring, lane change assistance, and forward collision warnings.

Even the newest ADAS systems are prone to false positives. For example, automotive manufacturers warn that forward collision warning systems are known on occasion to determine incorrectly that there is a possibility of a frontal collision in a wide variety of circumstances including: (1) when passing a vehicle or pedestrian, (2) when changing lanes while overtaking a preceding vehicle, (3) when overtaking a preceding vehicle that is changing lanes or making a left/right turn, (4) when rapidly closing on a vehicle ahead, (5) if the front of the vehicle is raised or lowered, such as when the road surface is uneven or undulating, (6) when approaching objects on the roadside, such as guardrails, utility poles, trees, or walls, (7) when driving on a narrow path surrounded by a structure, such as in a tunnel or on an iron bridge, (8) when passing a vehicle in an oncoming lane that is stopped to make a right/left turn, (9) when driving on a road where relative location to vehicle ahead in an adjacent lane may change, such as on a winding road, (10) when there is a vehicle, pedestrian, or object by the roadside at the entrance of a curve, (11) when there is a metal object (manhole cover, steel plate, etc.), steps, or a protrusion on the road surface or roadside, (12) when rapidly closing on an electric toll gate barrier, parking area barrier, or other barrier that opens and closes, (13) when using an automatic car wash, (14) when the vehicle is hit by water, snow, dust, etc. from a vehicle ahead, (15) when driving through dust, water, snow, steam or smoke, (16) when there are patterns or paint on the road or a wall that may be mistaken for a vehicle or pedestrian, (17) when driving near an object that reflects radio waves, such as a large truck or guardrail, (18) when driving near a TV tower, broadcasting station, electric power plant, or other location where strong radio waves or electrical noise may be present, (19) when a crossing pedestrian approaches very close to the vehicle, (20) when passing through a place with a low structure above the road (low ceiling, traffic sign, etc.), (21) when passing under an object (billboard, etc.) at the top of an uphill road, (22) when rapidly closing on an electric toll gate barrier, parking area barrier, or other barrier that opens and closes, (23) when driving through or under objects that may contact the vehicle, such as thick grass, tree branches, or a banner, or (24) when driving near an object that reflects radio waves, such as a large truck or guardrail.

In addition to false positives, even the newest ADAS systems may fail to detect forward crash hazards in numerous circumstances. For example, automotive manufacturers warn that the radar sensor and camera sensor may fail so detect forward crash hazards, preventing the system from operating properly in numerous circumstances, including: (1) if an oncoming vehicle is approaching your vehicle, (2) if a vehicle ahead is a motorcycle or bicycle, (3) when approaching the side or front of a vehicle, (4) if a preceding vehicle has a small rear end, such as an unloaded truck, (5) if a vehicle ahead is carrying a load which protrudes past its rear bumper, (6) if a vehicle ahead is irregularly shaped, such as a tractor or side car, (7) if the sun or other light is shining directly on a vehicle ahead, (8) if a vehicle cuts in front of your vehicle or emerges from beside a vehicle, (9) if a vehicle ahead makes an abrupt maneuver (such as sudden swerving, acceleration or deceleration), (10) when suddenly cutting behind a preceding vehicle, (11) when driving in inclement weather such as heavy rain, fog, snow or a sandstorm, (12) when the vehicle is hit by water, snow, dust, etc. from a vehicle ahead, (13) when driving through steam or smoke (14) when driving in a place where the surrounding brightness changes suddenly, such as at the entrance or exit of a tunnel (15) if a preceding vehicle has a low rear end, such as a low bed trailer, (16) if a vehicle ahead has extremely high ground clearance, (17) When a vehicle ahead is not directly in front of your vehicle, (18) when a very bright light, such as the sun or the headlights of oncoming traffic, shines directly into the camera sensor (19) when the surrounding area is dim, such as at dawn or dusk, or while at night or in a tunnel, (20) while making a left/right turn and for a few seconds after making a left/right turn and (21) while driving on a curve and for a few seconds after driving on a curve, among others.

In addition, conventional ADAS systems do not provide intelligent assistance regarding the safety, well-being, and condition of drivers and passengers inside the vehicle. Existing systems provide only the most rudimentary functionality to warn when seat belts are not buckled and to arm or disarm airbag systems.

### BRIEF DESCRIPTION OF THE DRAWINGS

Various embodiments in accordance with the present disclosure will be described with reference to the drawings, in which:

FIG. 1 is a multi-passenger vehicle that can utilize aspects of the various embodiments.

FIG. 2 illustrates a shuttle that can accommodate a human safety driver and a plurality of human passengers in accordance with various embodiments.

FIG. 3 illustrates a high-level system architecture according to one embodiment of the invention.

FIG. 4 illustrates a system architecture according to one embodiment of the invention.

FIG. 5 illustrates an example of a proposed architecture according to one embodiment of the invention.

FIG. 6 illustrates an exemplary system architecture suitable for practicing embodiments of the invention.

FIG. 7 illustrates the front of the cabin according to one embodiment of the invention

FIG. 8 illustrates the rear of the cabin according to one embodiment of the invention.

FIG. 9 illustrates the use of color (RGB) information, infrared (IR) information, and an IR filter together.

FIG. 10 illustrates the use of RGB information, IR information, and the IR filter together.

FIG. 11 illustrates the control topology for one embodiment of the multiple sensor camera module (MSCM).

FIG. 12 illustrates an embodiment of an MSCM.

FIG. 13 illustrates another embodiment of an MSCM.

FIG. 14 illustrates another embodiment of a Camera Module Layout.

FIG. 15 illustrate an LED and Flash control according to one embodiment of the invention.

FIG. 16 illustrates separate boxes located in physically diverse locations.

FIG. 17 illustrates one or more repeaters in one configuration.

FIG. 18 illustrates one or more repeaters in another configuration.

FIG. 19 illustrates block diagram using a repeater.

FIG. 20 illustrates an embodiment using a repeater configuration with multiple input and single aggregated output.

FIG. 21 illustrates another embodiment with two de-serializers.

FIG. 22 illustrates one example of camera types and locations.

FIG. 23 illustrates one embodiment of a driver user interface and configuration.

FIG. 24 illustrates an exemplary interior according to one embodiment of the invention.

FIG. 25 illustrates one embodiment of a deep neural network (DNN) pipeline suitable for the invention.

FIG. 26 illustrates fiducial points as landmarks on a person’s face.

FIG. 27 illustrates a flowchart of a method for gaze estimation, in accordance with one embodiment.

FIG. 28 illustrates a pipeline of neural networks suitable for determining Gaze Detection according to one embodiment.

FIG. 29 illustrates a flowchart of a method for ocular fiducial point estimation, in accordance with one embodiment.

FIG. 30 illustrates a flowchart of a method for eye region segmentation, in accordance with one embodiment.

FIG. 31 illustrates an example system for generating new settings and comparing them to the current values in accordance with one embodiment.

FIG. 32 illustrates an example system for generating new settings and comparing them to the current values in accordance with one embodiment.

FIG. 33 illustrates an example process for adjusting audio settings in accordance with one embodiment.

FIG. 34 illustrates an example process for adjusting mirror settings in accordance with various embodiments.

FIG. 35 illustrates a gaze detection DNN being used to classify the driver’s gaze as falling into a region.

FIG. 36 illustrates a scenario in which the gaze detection DNN detects that the driver’s gaze is directed at center traffic, and the controller detects cross-traffic in accordance with one embodiment.

FIG. 37 illustrates an example process that can be utilized in accordance with various embodiments.

FIG. 38 illustrates an example risk assessment module for determining whether a driver is impaired.

FIG. 39 illustrates one embodiment of the risk assessment flow, using optional variable rate inferencing (“VRI”).

FIG. 40 illustrates one example of a process that may be followed by the risk assessment module to determine whether to activate the autonomous driving system.

FIG. 41 illustrates a master display screen that can be utilized in accordance with various embodiments.

FIG. 42 illustrates an example process that can be utilized in accordance with various embodiments.

FIG. 43 illustrates one flow embodiment of the passenger danger detection and warning.

FIG. 44 illustrates an example process that can be utilized in accordance with various embodiments.

FIG. 45 illustrates one embodiment of an analysis for passenger in need of assistance.

FIG. 46 illustrates a process for assessing whether a passenger has left items in accordance with one embodiment.

FIG. 47 illustrates an example process that can be utilized in accordance with various embodiments.

FIG. 48 illustrates an example system for identifying a gesture of one or more persons as an additional factor of authentication.

FIG. 49 illustrates a shuttle using its rear-facing camera to detect the presence of a passenger and its forward-facing camera to detect a passing vehicle.

FIG. 50 illustrates an example neural network which can be used to identify an authorized external party and infer an initial 2-D pose for signal gesture interpretation in accordance with various embodiments.

FIG. 51 illustrates an example inferencing pipeline for signal recognition based on an identified gesture in accordance with various embodiments.

FIG. 52 illustrates an example process using a DNN pipeline to determine a driver’s gaze in accordance with various embodiments.

FIG. 53 illustrates an example Advanced SoC used to conduct risk assessments, and provide the notifications, warnings, and autonomously control the vehicle, in whole or in part in accordance with various embodiments.

FIG. 54 shows two Advanced SoCs connected by a high-speed interconnect to discrete GPUs in accordance with various embodiments.

FIG. 55, illustrates a further embodiment of the platform architecture in accordance with one embodiment.

FIG. 56 illustrates another embodiment of the platform architecture,

FIG. 57 illustrates an example process that can be utilized in accordance with various embodiments.

FIG. 58 illustrates a self-driving two-level bus in accordance with one embodiment.

FIG. 59 illustrates a self-driving articulated bus in accordance with one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Given at least some of the above deficiencies, a need exists for an improved, more accurate system that provides reliable notification of potential hazards, as well as accurate warnings and advice to drivers. A need exists for a system that not only provides accurate warnings and advice, but also is able to take corrective action, which may include controlling one or more vehicle subsystems, or when necessary, autonomously controlling the entire vehicle.

Various embodiments include systems and methods for merging input from sensors placed both inside and outside a vehicle, enabling the vehicle to more intelligently react to its passengers, driver, and environment around it. Even if the vehicle is not driving itself, the vehicle’s artificial intelligence (AI) assistant functionality can help keep the driver and passengers safe.

An example system in accordance with various embodiments can provide AI assistance to drivers and passengers, providing enhanced functionality beyond conventional ADAS technology. The system uses an extensive suite of sensors inside and outside the car, together with an advanced computing platform running a plurality of neural networks and supported with computer vision and speech processing algorithms. Using images from sensors in the vehicle, the system performs facial recognition, eye tracking, gesture recognition, head position, gaze tracking, body pose estimation, activity prediction and health assessment to monitor the condition and safety of the driver and passengers. The system tracks where the driver is looking to identify objects the driver might not see, such as cross-traffic and approaching cyclists. The system provides notification of potential hazards, advice, and warnings. When necessary for safety, the system is also configured to take corrective action, which may include controlling one or more vehicle subsystems or controlling the entire vehicle. When required for safety, the system will autonomously drive until the vehicle is safely parked.

In various embodiments, a system is always engaged and uses a pipeline of deep learning networks to track gaze, head and body movements, as well as conditions inside and outside of the vehicle. The system is further capable of having a conversation with the driver or passenger using advanced speech recognition, lip reading, and natural language understanding. According to embodiments of the present invention, the system can discern a police car from a taxi, an ambulance from a delivery truck, or a parked car from one that is about to pull out into traffic. It can even extend this capability to identify, without limitation, commonplace entities and objects, including entities exhibiting non-ideal behavior such as cyclists on the sidewalk and distracted pedestrians.

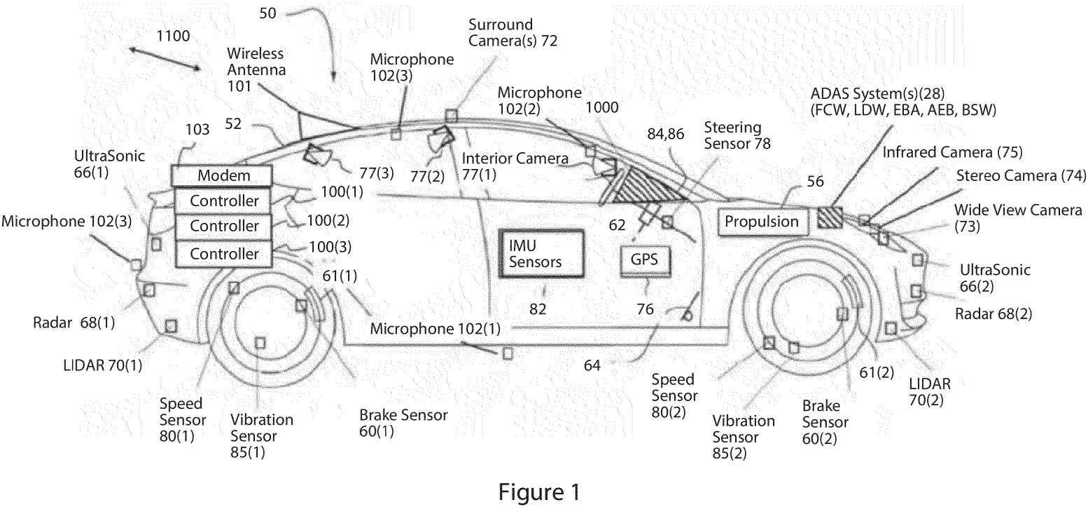

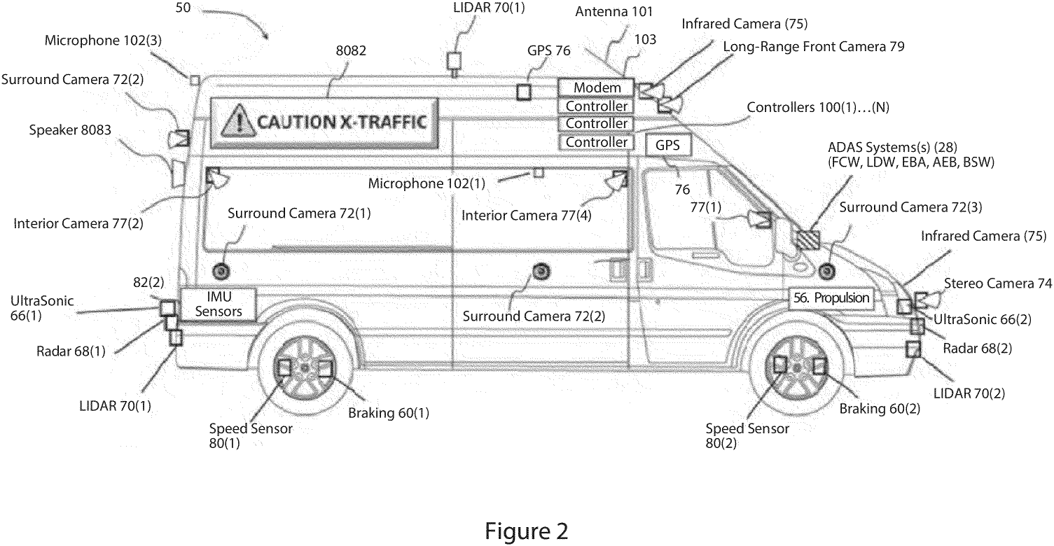

FIG. 1 and FIG. 2 illustrate two embodiments of Advanced AI-Assisted Vehicle (50). Vehicle (50) in FIG. 1 is a multi-passenger vehicle, such as a four-door sedan. Shuttle (50) in FIG. 2 comprises a shuttle that can accommodate a human safety driver and a plurality of human passengers. In some embodiments, the shuttle (50) includes 6-10 passenger capacity, fully autonomous capability, walk-in doors, automated doors, and disability accessibility.

Vehicle (50) includes a vehicle body suspended on a chassis, in this example comprising four wheels and associated axles. A propulsion system (56) such as an internal combustion engine, hybrid electric power plant, or all-electric engine can be connected to drive wheels via a drive train, which may include a transmission (not shown). A steering wheel may be used to steer wheels to direct the vehicle (50) along a desired path when the propulsion system (56) is operating and engaged to propel the vehicle. The vehicles may include one or more conventional ADAS sub-systems (28), including but not limited to Blind Spot Warning (BSW), Automatic Emergency Braking (AEB), Lane Departure Warning (LDW), Emergency Brake Assist (EBA), and Forward Crash Warning (FCW) systems.

One or more Controllers (100(1)-100(N)) comprise an advanced computing platform running a plurality of neural networks, computer vision and speech algorithms. As explained in detail below, the controllers provide notification of potential hazards, advice, and warnings to assist the driver. When necessary for safety, the system is also configured to take corrective action, which may include controlling one or more vehicle subsystems or controlling the entire vehicle. When required for safety, the system will autonomously drive until the vehicle is safely parked or perform other autonomous driving functionality.

Each controller is essentially one or more onboard supercomputers that can operate in real-time to process sensor signals and output autonomous operation commands to self-drive vehicle (50) and/or assist the human vehicle driver in driving. Each vehicle may have any number of distinct controllers for functional safety and additional features. For example, Controller (100(1)) may provide artificial intelligence functionality based on in-cabin sensors to monitor driver and passengers and provide advanced driver assistance, Controller (100(2)) may serve as a primary computer for autonomous driving functions, Controller (100(3)) may serve as a secondary computer for functional safety, and Controller (100(4)) (not shown) may provide infotainment functionality and provide additional redundancy for emergency situations.

Controller (100(1)) receives inputs from sensors inside the cabin, including interior cameras (77(1)-(N)) as discussed herein, without limitation. Controller (100(1)) also receives input from ADAS systems (28) (if present) as well as information from Controller (100(2)), which uses AI and deep learning to perform perception and risk identification tasks, as discussed, without limitation, elsewhere herein.

Controller (100(1)) performs risk assessment functionality as described, without limitation, using inputs from ADAS systems (28) (if present) and Controller (100(2)). When necessary, Controller (100(1)) instructs Controller (100(2)) to take corrective action, which may include controlling one or more vehicle subsystems, or when necessary, autonomously controlling the entire vehicle. Controller (100(1)) also receives inputs from an instrument cluster (84) and can provide human-perceptible outputs to a human operator via human-machine interface (“HMI”) display(s) (86), an audible annunciator, a speaker and/or other means.

In addition to traditional information such as velocity, time, and other well-known information, HMI display (86) may provide the vehicle occupants with maps and information regarding the vehicle’s location, the location of other vehicles (including occupancy grid and/or world view) and even the Controller’s identification of objects and status. For example, HMI display (86) may alert the passenger when the controller has identified the presence of a new element, such as (without limitation): a stop sign, caution sign, slowing and braking vehicles around the AI-assisted vehicle, or changing traffic lights The HMI display (86) may indicate that the controller is taking appropriate action, giving the vehicle occupants peace of mind that the controller is functioning as intended. Controller (100(1)) may be physically located either inside or outside of the instrument cluster (84) housing. In addition, instrument cluster (84) may include a separate controller/supercomputer, configured to perform deep learning and artificial intelligence functionality, including the Advanced System-on-a-Chip described below.

Controller (100(2)) sends command signals to operate vehicle brakes (60) via one or more braking actuators (61), operate steering mechanism via a steering actuator (62), and operate propulsion unit (56) which also receives an accelerator/throttle actuation signal (64). Actuation is performed by methods known to persons of ordinary skill in the art, with signals typically sent via the Controller Area Network (“CAN bus”)-a network inside modern cars used to control brakes, acceleration, steering, windshield wipers, etc. The CAN bus may be preferred in some embodiments, but in other embodiments, other buses and connectors, such as Ethernet, may be used. The CAN bus can be configured to have dozens of nodes, each with its own unique identifier (CAN ID). In one embodiment, the CAN network comprises 120 different CAN node IDS, using Elektrobit’s EasyCAN configuration. The bus can be read to find steering wheel angle, ground speed, engine RPM, button positions, and other vehicle status indicators. The functional safety level for a CAN bus interface is typically Automotive Safety Integrity Level B (ASIL B), requiring moderate integrity requirements. Other protocols may be used for communicating within a vehicle, including FlexRay and Ethernet. For embodiments using vehicle models such as the Lincoln MKZ, Ford Fusion, or Mondeo, an actuation controller, with dedicated hardware and software, may be obtained from Dataspeed, allowing control of throttle, brake, steering, and shifting. The Dataspeed hardware provides a bridge between the vehicle’s CAN bus and the controller (100), forwarding vehicle data to controller (100) including the turn signal, wheel speed, acceleration, pitch, roll, yaw, Global Positioning System (“GPS”) data, tire pressure, fuel level, sonar, brake torque, and others.

Controller (100(2)) provides autonomous driving outputs in response to an array of sensor inputs including, for example: one or more ultrasonic sensors (66), one or more RADAR sensors (68), one or more Light Detection and Ranging (“LIDAR”) sensors (70), one or more surround cameras (72) (typically such cameras are located at various places on vehicle body (52) to image areas all around the vehicle body), one or more stereo cameras (74) (in various embodiments, at least one such stereo camera faces forward to provide depth-perception for object detection and object recognition in the vehicle path), one or more infrared cameras (75), GPS unit (76) that provides location coordinates, a steering sensor (78) that detects the steering angle, speed sensors (80) (one for each of the wheels), an inertial sensor or inertial measurement unit (“IMU”) (82) that monitors movement of vehicle body (52) (this sensor can include, for example, an accelerometer(s) and/or a gyrosensor(s) and/or a magnetic compass(es)), tire vibration sensors (85), and microphones (102) placed around and inside the vehicle. Other sensors may be used, as is known to persons of ordinary skill in the art.

The vehicle includes a modem (103), preferably a system-on-a-chip that provides modulation and demodulation functionality and allows the controller (100(1) and 100(2)) to communicate over the wireless network (1100). Modem (103) may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem (103) preferably includes wireless functionality such as LTE, WCDMA, UMTS, GSM, CDMA2000, or other known and widely-used wireless protocols.

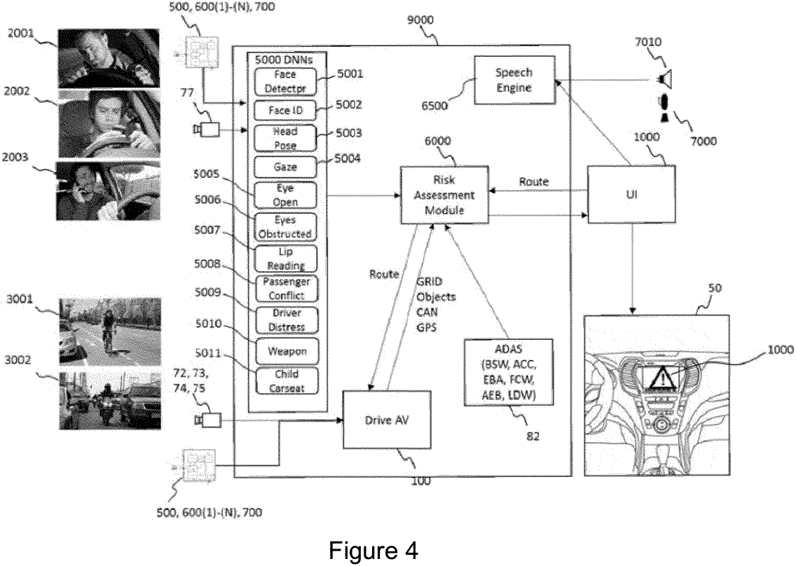

Vehicle (50) may send and/or receive a wide variety of data to the wireless network. For example, vehicle (50) collects data that is preferably used to help train and refine the neural networks used for self-driving and occupant monitoring. Vehicle (50) may also send notifications to a system operator or dispatch (in the case of shuttles, buses, taxis, and patrol cars), or requests for emergency assistance, if requested by the risk assessment module (6000) (presented with FIG. 4).

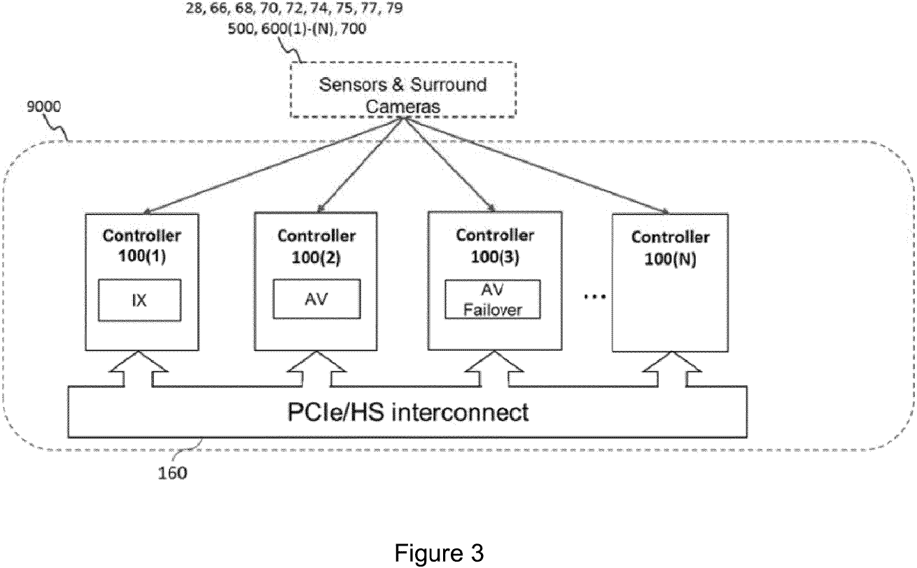

FIG. 3 illustrates a high-level system architecture according to one embodiment of the invention. The system (9000) preferably includes a plurality of controllers (100(1)-100(N)), including a controller and system for autonomous or semi-autonomous driving (100), such as the systems described in U.S. Provisional Application Nos. 62/584,549, filed Nov. 10, 2017, Application No. 62/614,466, filed Jan. 7, 2018, and Application No. 62/625,351, filed Feb. 2, 2018.

One or more of the controllers (100(1)) may include an Advanced SoC or platform used to execute an intelligent assistant software stack (IX) that conducts risk assessments and provides the notifications, warnings, and autonomously control the vehicle, in whole or in part, executing the risk assessment and advanced driver assistance functions described herein. Two or more of the controllers (100(2), 100(3)) are used to provide for autonomous driving functionality, executing an autonomous vehicle (AV) software stack to perform autonomous or semi-autonomous driving functionality. The controllers may comprise or include the Advanced SoCs and platforms described, for example, in U.S. Application No. 62/584,549, incorporated by reference.

As explained in in U.S. Application No. 62/584,549, an Advanced Platform and SoC for performing the invention preferably has multiple types of processors, providing the “right tool for the job” as well as processing diversity for functional safety. For example, GPUs are well-suited to higher precision tasks. Hardware accelerators, on the other hand, can be optimized to perform a more specific set of functions. By providing a blend of multiple processors, an Advanced Platform and SoC includes a complete set of tools able to perform the complex functions associated with Advanced AI-Assisted Vehicles quickly, reliably, and efficiently.

FIG. 4 illustrates a system architecture according to one embodiment of the invention. System (9000) includes a controller and system for autonomous or semi-autonomous driving (100), such as the systems described in U.S. Provisional Application Nos. 62/584,549, filed Nov. 10, 2017, Application No. 62/614,466, filed Jan. 7, 2018, and Application No. 62/625,351, filed Feb. 2, 2018.

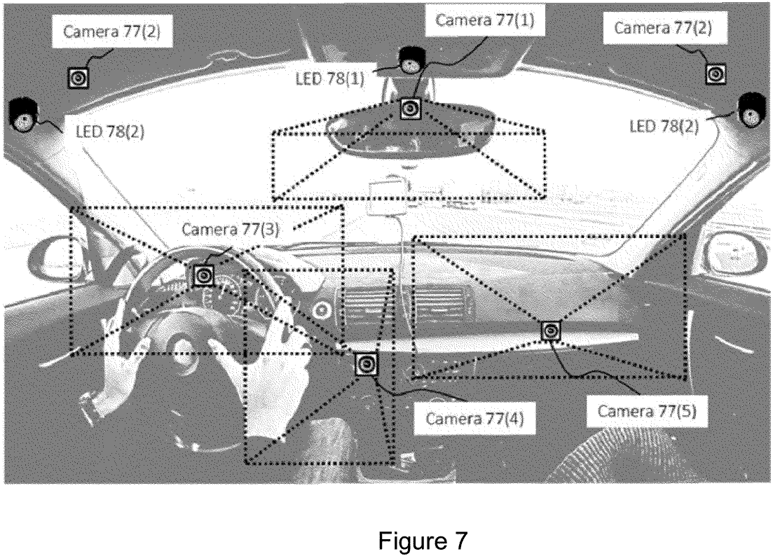

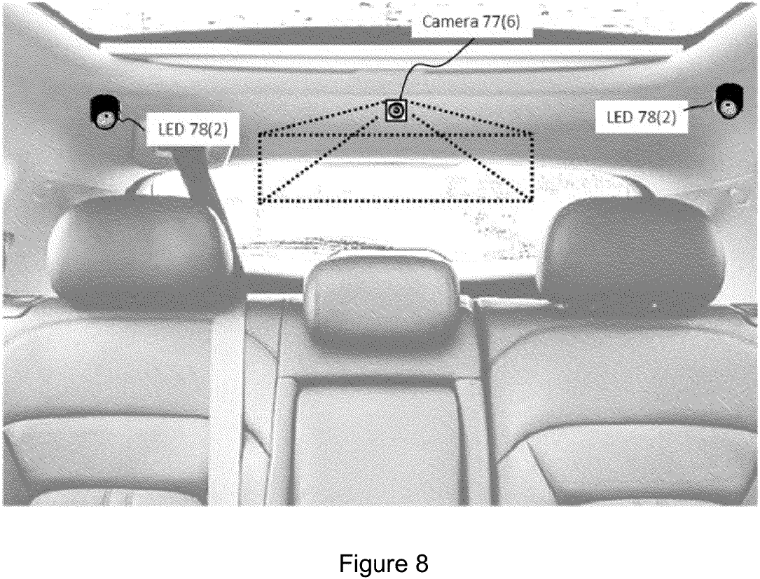

Controller (100) receives input from one or more cameras (72, 73, 74, 75) deployed around the vehicle. Controller (100) detects objects and provides information regarding the object’s presence and trajectory to the risk assessment module (6000). System includes a plurality of cameras (77) located inside the vehicle. Cameras (77) may be arranged as illustrated in FIG. 7 and FIG. 8, or in any other manner to provide coverage of the driver and other occupants. Cameras (77) provide input to a plurality of deep neural networks (5000) for monitoring the driver, other occupants, and/or conditions in the vehicle. Alternatively, multi-sensor camera modules (500), (600(1)-(N)), and/or (700) may be used to view either the inside of the vehicle or the outside environment.

The neural networks preferably are trained to detect a number of different features and events, including: the presence of a face (5001), the identity of a person in the driver’s seat or one or more passenger seats (5002), the driver’s head pose (5003), the direction of the driver’s gaze (5004), whether the driver’s eyes are open (5005), whether the driver’s eyes are closed or otherwise obstructed (5006), whether the driver is speaking, and, if so, what the driver is saying (by audio input or lip-reading) (5007), whether the passengers are in conflict or otherwise compromising the driver’s ability to control the vehicle (5008), and whether the driver is in distress (5009). In additional embodiments, the networks are trained to identify driver actions including (without limitation): checking a cell phone, drinking, smoking, and driver intention, based on head and body pose and motion. In one embodiment, head pose may be determined as described in U.S. Application No. 15/836,549 (Attorney Docket No. 17-SC-0012US01), filed Dec. 8, 2017, incorporated by reference.

In the embodiment illustrated in FIG. 4, the AV stack and the IX stack may both execute on the same platform or SoC (9000).

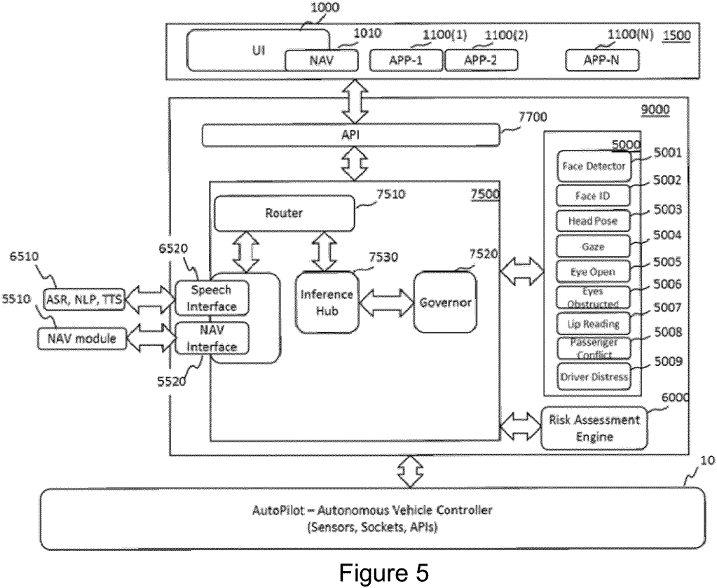

FIG. 5 is another example of a proposed architecture according to one embodiment of the invention. In the embodiment of FIG. 5, the AV stack and the IX stack may execute on physically distinct platforms and/or SoCs. This embodiment is only an example. In other embodiments a vehicle may include multiple copies of the IX stack, each on distinct platforms and/or SoCs. System includes Autonomous Vehicle Controller (100), such as the systems described in U.S. Provisional Application Nos. 62/584,549, filed Nov. 10, 2017, Application No. 62/614,466, filed Jan. 7, 2018, and Application No. 62/625,351, filed Feb. 2, 2018. Controller (100) detects objects and provides information regarding the object’s presence and trajectory to controller (9000), which includes risk assessment module (6000). In this embodiment, controller (9000) executes a plurality of deep neural networks (5000) for monitoring the driver and/or conditions in the vehicle.

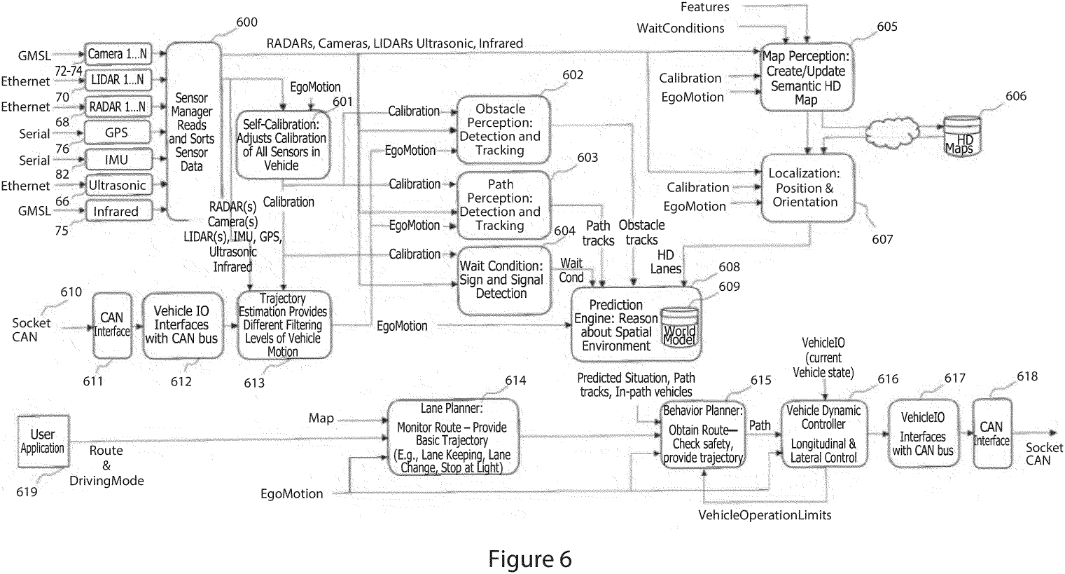

The AI supercomputer (100) can run networks specifically intended to recognize certain objects and features. FIG. 6, below shows an exemplary system architecture suitable for practicing embodiments of the invention. Obstacle Perception (602) running in the AI supercomputer (100) can run networks specifically intended to recognize certain objects, obstacles, and features, including, without limitation, (1) LaneNet (for detecting lanes), (2) PoleNet (for detecting traffic poles), (3) WaitNet (for detecting wait conditions and intersections), (4) SignNet (for detecting traffic signs), (5) LightNet (for detecting traffic lights), and others.

An exemplary camera layout of the cabin is illustrated in FIG. 7 and FIG. 8, below. FIG. 7 illustrates the front of the cabin according to one embodiment of the invention. The cabin preferably includes at least two cameras directed to the driver. In one embodiment, driver primary camera (77(3)) detects IR light at a 940 nm wavelength, 60 degree field of view, and takes images at 60 fps. Driver primary camera (77(3)) is preferably used to determine for Face ID and to determine the driver’s gaze, head pose, and detect drowsiness. Alternatively, driver primary camera may be replaced with a multi-sensor camera module (500), (600(1)-(N)), and/or (700), providing both IR and RGB camera functionality.

In one embodiment, Driver Secondary camera (77(4)) is an infrared (IR) at a 940 nm wavelength, with a 60 degree field of view, taking images at 60 frames per second. Driver Secondary camera (77(4)) is preferably used together with Driver primary camera (77(3)) to determine the driver’s gaze, head pose, and detect drowsiness. Alternatively, driver secondary camera may be replaced with a multi-sensor camera module (500), (600(1)-(N)), and/or (700), providing both IR and RGB camera functionality.

The cabin preferably includes at least one Cabin Primary Camera (77(1)), typically mounted overhead. In one embodiment, Cabin Primary Camera (77(1)) is an IR at a 940 nm wavelength camera with Time of Flight (ToF) Depth, 90 degree field of view, and taking images at 30 fps. Cabin Primary Camera (77(1)) is preferably used to determine gestures and cabin occupancy. The cabin preferably includes at least one passenger camera 77(5), typically mounted near the passenger glove compartment or passenger-side dash. In one embodiment, Passenger Camera (77(5)) is an IR at a 940 nanometer wavelength, 60 degree field of view, taking images at 30 fps. Alternatively, driver primary camera may be replaced with a multi-sensor camera module (500), (600(1)-(N)), and/or (700), providing both IR and RGB camera functionality.

The front of the cabin preferably includes a plurality of LED illuminators, (78(1)-(2)). The illuminators preferably cast IR light at 940 nm, and are synced with the cameras, and are eye safe. The front of the vehicle also preferably includes a low angle camera, to determine when the driver is looking down (as compared to when the driver’s eyes are closed).

The cabin also preferably has a “cabin secondary” camera (not shown), which provides a view of the whole cabin. The cabin secondary camera is preferably mounted in the center of the roof and has wide angle lenses, providing a view of the full cabin. This allows the system to determine occupancy count, estimate an age of the occupants, and perform object detection functions. In other embodiments, the system includes dedicated cameras for front and rear passengers (not shown). Such dedicated cameras allow the system to perform video conferences with occupants in the front or the rear of the vehicle.

FIG. 8 illustrates the rear of the cabin according to one embodiment of the invention. Camera (77(6)) is preferably a IR at a 940 nm wavelength camera, with a 90 degree field of view, shooting images at 30 fps. Alternatively, driver primary camera may be replaced with a multi-sensor camera module (500), (600(1)-(N)), and/or (700), providing both IR and RGB camera functionality. Camera (77(6)) is preferably used to determine cabin occupancy. The rear of the cabin preferably includes a plurality of LED illuminators, (78(2)). The illuminators preferably cast IR light at 940 nm, and are synced with the cameras, and are eye safe.

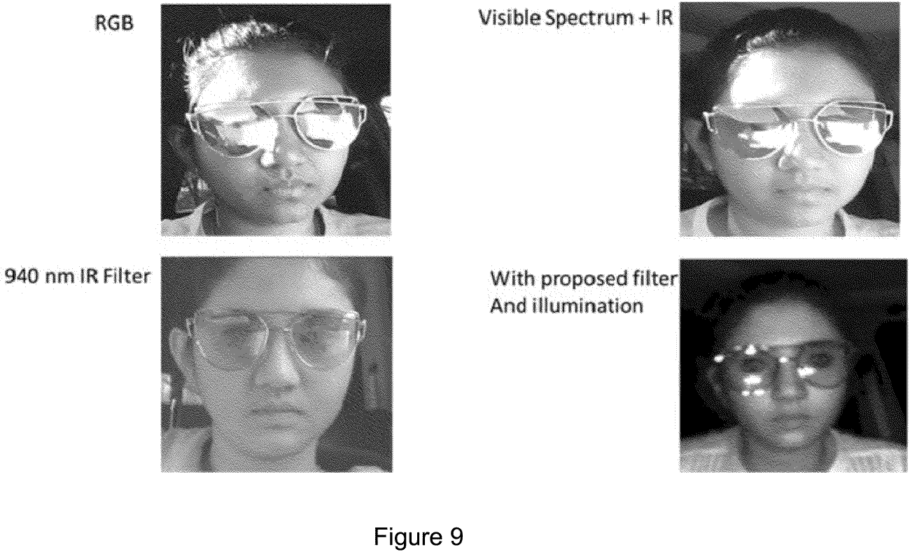

According to various embodiments, the system detects gaze under a variety of conditions, including, without limitation, when the driver is wearing clear glasses, sunglasses, and when the driver has only one eye. The use of RGB, IR, and the 940 nm IR filter together provides robust performance with most sunglasses, as illustrated in FIG. 9.

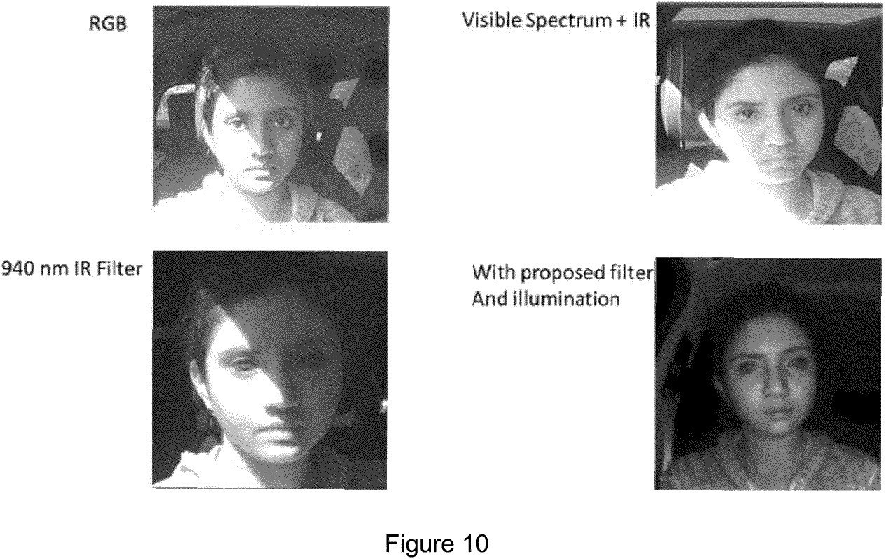

The system is also able to function against harsh environmental lighting. Again, the use of RGB, IR, and the 940 nm IR filter together provides robust performance against most conditions of harsh environmental lighting, as illustrated in FIG. 10.

The autonomous vehicle (50) may include one or more multi-sensor camera modules (MSCM) that provide for multiple sensors in a single housing and allow for interchangeable sensors as well. An MSCM according to various embodiments can be used in various configurations: (1) IR + IR (IR stereo vision), (2) IR + RGB (Stereo vision and pairing frames), (3) RGB + RGB (RGB stereo vision). The RGB sensor can be replaced with RCCB (or some other color sensor) depending on color and low light performance required. The MSCM may be used for cameras covering the environment outside the vehicle, cameras covering the inside of the vehicle, or both.

The MSCM has many advantages over the conventional approach. Because the MSCM has at least two (or more) sensors, it can provide stereo images and enhanced depth perception capability. Stereo images enable the use of computer vision concepts to assess depth (distance from camera) of objects visible to both sensors. Furthermore, the MSCM’s bi-modal capability (RGB and IR) allows the system to operate in the mode that is most advantageous for the current environment, time, and lighting conditions. For example, in one embodiment the MSCM can operate in RGB mode by default. In this mode the images are also usable for features such as driver monitoring, passenger monitoring, lip reading, video-conferencing, and surveillance. However, RGB does not perform well in extreme lighting conditions, such as dark interiors (tunnel, shadows, night time) and very bright conditions (sun light directly in the cabin) that make RGB input saturated and not usable. The MSCM’s parallel IR input allows the system to switch inferencing essentially immediately (within one frame latency) to IR input.

The MSCM’s multi-mode ability is advantageous to limit excessive use of IR lighting and IR cameras, especially for in-cabin applications. Studies suggest that excessive use of IR lighting can cause eye dryness and other physical discomfort. Thus, in some embodiments an MSCM preferably uses the IR lighting only when necessary.

An MSCM according to one or more embodiments provides a universal option that solves for RGB being ineffective in some conditions and IR being uncomfortable if used all the time. The MSCM allows for RGB (color sensor) to be used to provide human consumable images (e.g., for a video call for example) while continuing to use the IR camera for operational aspects. The MSCM provides depth information, which allows for gaze and head pose parameters to be more accurate and to assess the spatial arrangement of people and objects in the field of view of the MSCM. In one embodiment, the MSCM may be used in multiple modes of operation, including: (1) 60 frames-per-second (fps) synchronous or non-synchronous, (2) 30 fps synchronous or non-synchronous, (3) 60 fps from one sensor and 30 fps from other, synchronous or non-synchronous, and (4) alternate frames at 30 fps from sensors.

The MSCM’s multi-mode capability allows for IR to be used to calibrate and train a neural network that uses RGB images. For example, each passenger and each new driver has a unique profile, head size, hair style and accessories (hat, etc.), and posture. They may have adjusted the seats or be leaning in the vehicle. The MSCM’s multi-mode capability allows the system to use IR + RGB information to calibrate and train a neural network for the correct head position; after training, the system can switch to RGB only, to limit the exposure of the driver and passenger to IR.

The MSCM preferably accommodates both color and IR sensors. The MSCM can preferably communicate over any one of a single GMSL Wire, GMSL2 and control over back channel, or be configured to work with any combination thereof. In one embodiment, the MSCM can accommodate multiple LED connectors and individual LED brightness control. The MSCM preferably provides for synchronous capture from IR and RGB camera. Furthermore, MSCM preferably includes current sense and alert of LEDs. In one embodiment, the MSCM has LEDs separable up to a few meters from the camera module and EMI protection. Furthermore, the MSCM provides for fault indications (FLTS) from LED modules to MCU. Power for the LEDs in the MSCM may be provided from a separate battery or from the vehicle’s power system. Power for the camera sensors may be provided over a coaxial cable. Finally, power for the camera may be provided separate from the power for LEDs.

The MSCM may synchronize the cameras and lighting sources in a variety of ways. For example, the MSCM may synchronize using the flash from the IR Sensor as the input for synchronization of the Color Sensor. Alternatively, the MSCM may synchronize using the Color Sensor as the input for synchronization of the IR Sensor.

In various embodiments, a system can receive a first image captured using reflected light from a first light source at a first location and a second image captured using reflected light from a second light source at a second location. The first image and/or the second image can be represented as data communicated from the camera(s) to a processing and analysis system. The images can be color images (e.g., with red, green, and blue information), grayscale images, infrared images, depth images, etc. The images can be a combination of aforementioned image types. In some embodiments, the first image and the second image represent the same light spectra; alternatively or additionally, the images can represent different wavelengths of light (e.g., one image can be color while the other can be infrared).

In some embodiments, the two images can be captured from the same camera but taken sequentially. For example, the first image can be taken while the subject is illuminated with an infrared light from the left side. The light on the left can then be deactivated and a different light from the right side can be activated; the second image can then be captured using the camera. Additionally or alternatively, the first image and the second image can be captured by different cameras.

The first light source and/or the second light source can be an LED, bulb, external source (e.g., a street light, another vehicle’s headlights, the sun, etc.), or other light source. The first light source and/or the second light source can be an infrared (IR) light emitting diode (LED) or IR LED pairs. The two light sources can be adjusted by the system. For example, an adjustable filter can be applied to limit the intensity of the light (or the intensity of certain wavelengths of light from the light source). The system can adjust a power to the light source. For example, the system can decrease the voltage to the light source, can limit the duty cycle of the light source (e.g., through pulse-width-modulation), or reduce a number of active emitters of the light source (e.g., turning off half of the LEDs in an LED array). The system can change a position, direction, spread, or softness of a light source (e.g., by moving the light source, moving a lens of the light source, moving a diffuser for the light source, etc.).

The two light sources can be located at different places. For example, one light source can be located at or near a steering wheel of a vehicle while another can be located at or near the rear-view mirror of the vehicle. A light source can provide primarily direct light (e.g., being pointed directly at the subject) or indirect light (e.g., pointed at the ceiling or floor and relying on environmental reflections to illuminate the subject with softer light).

The system can analyze the images and determine that one image has a region of saturated pixel values. For example, that image may be overexposed (e.g., from sunlight) or have an overexposed region (e.g., glare on a person’s glasses). If the image supports a range of pixel values from 0 to 255 and a region of pixel values are at or near 255 (or other predefined threshold), then the system can determine that the region is saturated. In some embodiments, the same principles pertaining to saturated pixels values can be applied to undersaturated pixel values such as might occur if an image is underexposed or there is an object on the camera lens or sensor occluding the image. In some embodiments, the system ignores saturated regions that are outside of a region of interest. For example, if a driver’s face is the region of interest and the saturated region is outside of the driver’s face region (e.g., the sky behind the driver and in the periphery of the image), then the system can ignore the fact that the region is saturated.

The system can select an image of the two images (e.g., the first image) based on detecting the region of saturated pixel values in the second image. The selected image can then be used for analysis of a state of a driver (e.g., whether the driver is distracted, asleep, looking at an object, etc. as described herein). In some embodiments, the image can be sent to a system configured to detect the state of the driver such as a deep neural network as discussed herein. In some embodiments, the image with the saturated region is discarded at a system connected directly to the camera to minimize data transmissions on a shared vehicle data bus.

The system can then modify a pattern of operation of at least the second light source (e.g., the light source associated with the image having a saturated region) based in part upon detecting the region of the saturated pixel values. For example, the system can decrease the power, duty cycle duration, number of emitters, etc. of the light source. In some embodiments, the system can place a filter over the light source. The system can increase the filter power of a filter (e.g., for a filter with gradient controls such as an LCD filter). In some embodiments, the light source can comprise multiple emitters (e.g., a high powered emitter and a low power emitter) and the system can switch between a higher intensity emitter and a lower intensity emitter. The system can, in various embodiments, deactivate the light source entirely. If the light source has multiple sub-light sources, the system can determine which sub-light source is emitting the light that results in the saturated pixel and the system can adjust the pattern of that sub-light source. In some embodiments, modifying the pattern of the light source can include increasing the intensity of the second light source so that the image is more uniformly illuminated. For example, if the saturated region is caused by some sunlight reflecting off of the surface of a driver, the system can increase the intensity of infrared lights pointed at the driver to match or overcome the intensity of the reflection.

The system can determine at least one environmental parameter impacting operation of a camera capturing the first image and the second image. For example, the system can determine that glare from an environmental light source (e.g., the sun, headlights from another car, etc.) are impacting the camera. Such glare can be located on a lens of the camera. The environmental parameter can include that the driver is wearing sunglasses. The system can modify the operation of the first light source, the second light source, and/or a third light source to adapt to the environmental parameter. For example, the light source can counteract bright light from the sun, illuminate a driver with sunglasses, etc.

As discussed herein, the detected driver state can include one or more of: being asleep, drowsy, inattentive (e.g., being distracted by a phone, passenger, or outside object), in medical distress (e.g., a stroke or seizure), in a heightened emotional state (e.g., angry or otherwise upset which may result in risky driving), intoxicated, normal, distracted, tired, abnormal, emergency, etc. The state of the driver can be determined based on one or more of the driver’s gaze (e.g., what the driver is looking at), the driver’s facial expression (e.g., as determined by identified eye, nose, mouth, and cheek features), the driver’s complexion (e.g., color of the driver’s skin which may reveal stress or sickness), etc. The driver state can be determined from a single image or a series of images over time. The driver state can be inferred using a trained neural network as described herein.

The system can modify the operation of a vehicle under at least partial control of the driver based at least in part upon the state of the driver as determined, at least in part, using the first image. For example, the system can slow the vehicle, stop the vehicle, assume control of the vehicle (e.g., to stay within lines or make a turn), communicate to the driver (e.g., through visual or audible warnings), adjust the environment of the vehicle (e.g., rolling down the windows, adjusting the temperature in the vehicle, turning music down or up, etc.), communicate with an external service (e.g., call an ambulance, friend of the driver, or system operator), or tune settings of an autonomous (or semi-autonomous) driving system to mitigate dangerous human input (e.g., if the driver slams on the accelerator aggressively, temper the acceleration of the car). The modification of the operation of the car can include changing a destination of the vehicle (e.g., to a hospital) or a travel path of the vehicle (e.g., to avoid dangerous roads or intersections).

As discussed herein, the system can modify the operation of the first light source, the second light source, and/or a third light source by modifying at least one of a polarization, a brightness, a frequency of operation, an active state, an active duration, or a wavelength, of the light source.

The system can identify at least one eye region of the driver in the second image, wherein the region of saturated pixel values in the second image includes over a threshold number of pixels in the eye region having a maximum pixel value. For example, the system can determine that there is a significant amount of glare from glasses at the eye region. This may make it difficult to determine the status of the eye (e.g., whether the eye is opened or closed and where the eye is looking).

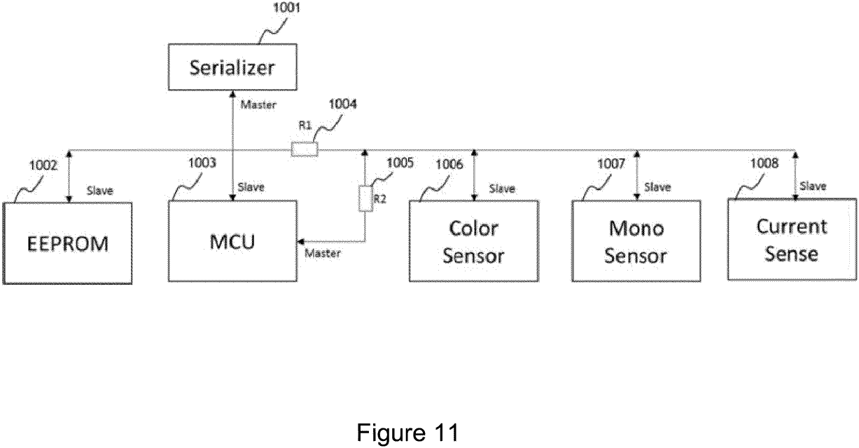

FIG. 11 illustrates the control topology for one embodiment of the multiple sensor camera module. Module includes EEPROM (1002), MCU (1003), Color Sensor (1006), Mono Sensor (1007), and Current Sense, (1008). Module also includes configurable resistors R1 (1004) and R2 (1005). At assembly time, the resistance of R1 and R2 may be adjusted to break the circuit (infinite resistance or an open circuit) or connect the circuit (by “stuffing” to provide a very low resistance, approximating a closed circuit). This allows the camera to be configured in one of two modes: (1) all I2c devices are controlled by a microcontroller on camera module, or (2) all I2C devices are controlled by one of the Advanced SoCs in Controllers (100(1)-(N)). Stated differently, R1 (1004) stuffing allows for Serializer (1001) to connect to an SoC which can be master of all the devices. R2 (1005) stuffing allows MCU (1003) to be Master and as pass-through from Serializer (1001) to other sensors.

In one embodiment, the MSCM is configured at assembly time. Alternatively, the MSCM may be re-configured post-assembly, allowing electrical rework and/or stuffing to be performed in the field. For example, the MSCM may include one or more dip switches, providing for in-the-field configurability. R1 and R2 can also be programmable and be configured in software.

As FIG. 11 illustrates, the control topology may include current sense device (1008), which allows the amount of current being drawn across that circuit to be measured. Combined with the voltage (which may be fixed at design time or set programmatically) information from the current sense device (1008) allows the device to determine the instantaneous power being consumed. Suitable current sense devices include the Microchip PAC1710, a high-side bidirectional current sensing monitor with precision voltage measurement capabilities. The power monitor measures the voltage developed across an external sense resistor to represent the high-side current of a battery or voltage regulator. The PAC1710 also measures the SENSE + pin voltage and calculates average power over the integration period. The PAC1710 can be programmed to assert the ALERT# pin when high and low limits are exceeded for Current Sense and Bus Voltage. Alternatively, other current sense devices may be used. This allows the MSCM to monitor its instantaneous power consumption and shut down the device if prescribed limits are exceeded. It can also be used to monitor and correct for lifetime and long-term changes to power characteristics and correct the operating parameters for aging and thermal effects.

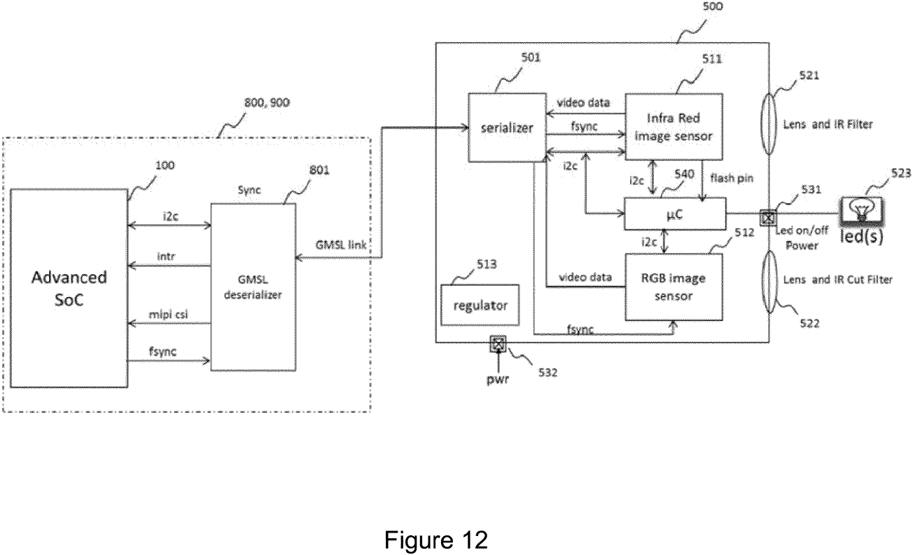

FIG. 12 illustrates an embodiment of an MSCM. In this embodiment, MSCM (500) is coupled to one or more AI Supercomputers (800), (900) suitable for controlling an autonomous or semi-autonomous vehicle. In this embodiment, AI Supercomputers (800), (900) include one or more Advanced SoCs, as described in U.S. Provisional Application Nos. 62/584,549, filed Nov. 10, 2017.

Multiple sensor camera module (500) comprises serializer (501), IR Image Sensor (511), RGB Image Sensor (512), lens and IR filters (521), and microcontroller (540). Many camera sensors may be used, including the OnSemi AR0144 (1.0 Megapixel (1280 H x 800 V), 60fps, Global Shutter, CMOS). The AR0144 reduces artifacts in both bright and low-light conditions and is designed for high shutter efficiency and signal-to-noise ratio to minimize ghosting and noise effects. The AR0144 may be used both for the Color Sensor (1006) and Mono Sensor (1007).

Many different camera lenses (521, 522) may be used. In one embodiment, the camera lenses are LCE-C001 (55 HFoV) with 940 nm band pass. The LED lens is preferably a Ledil Lisa2 FP13026. In one embodiment, each lens is mounted in a molded polycarbonate (PC) housing designed for alignment to a specific LED, providing precise location of the lens at the ideal focal point for each qualified brand or style of LED. Other LED lenses may be used.

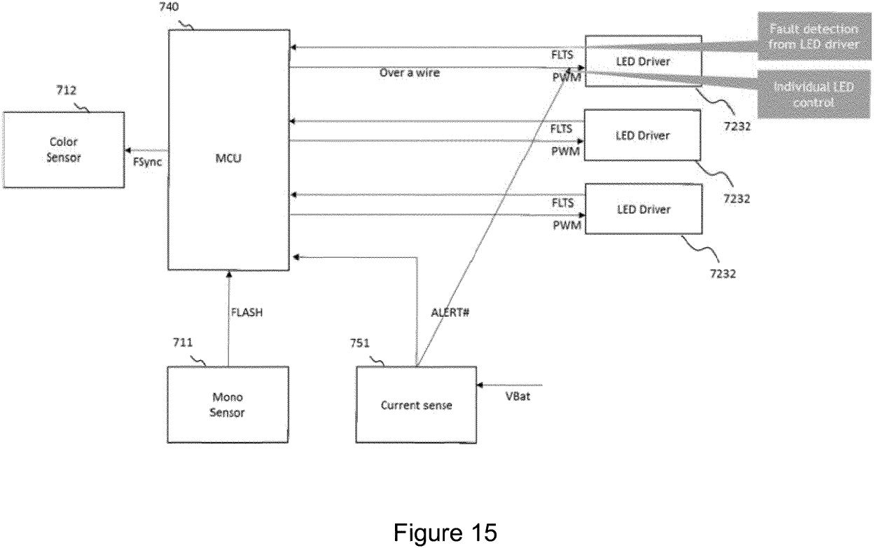

In the embodiment illustrated in FIG. 12, the MSCM controls one or more LEDs (523). These LED are automotive qualified and provide infrared illumination for cameras, in the form of highly-concentrated non-visible infrared light. In one embodiment, LED is an Osram Opto SFH4725S IR LED (940 nm). The LEDs (523) are controlled by switch (531), which flashes the LEDs, as illustrated further in connection with FIG. 15. The LED lens is preferably a Ledil Lisa2 FP13026. Other LEDs and lenses may be used.

The Serializer is preferably a MAX9295A GMSL2 SER, though other Serializers may be used. Suitable microcontrollers (MCUs) (540) include the Atmel SAMD21. The SAM D21 is a series of low-power microcontrollers using the 32-bit ARM Cortex processor and ranging from 32- to 64-pins with up to 256KB Flash and 32KB of SRAM. The SAM D21 devices operate at a maximum frequency of 48 MHz and reach 2.46 CoreMark/MHz. Other MCUs may be used as well. The LED Driver (523) is preferably an ON-Semi NCV7691-D or equivalent, though other LED drivers may be used.

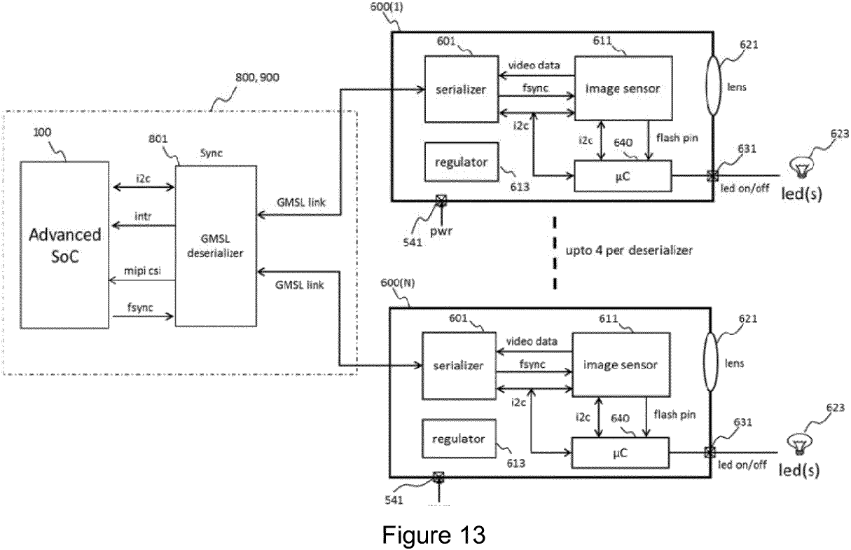

FIG. 13 illustrates another embodiment of an MSCM. In this embodiment, the MSCM includes a plurality of sensor modules (600(1)-(N)), up to (without limitation) four per deserializer. In one embodiment, each of the sensor modules is mounted in a single housing, and on a single PCB. The image sensors (611) in each sensor module (600) may be either RGB or IR. The plurality of sensor modules (600(1)-(N)) may be mounted in separate locations on the vehicle, enabling stereo images and enhanced depth perception capability. Stereo images enable the use of computer vision concepts to assess depth (distance from camera) of objects visible to both sensors.

To achieve stereo capability the lenses should be aligned parallel to each other. To solve this problem, the system includes a self-calibration capability, during which images are captured from each of the sensors – both at factory and periodically during use of the product to programmatically detect minor deviations due to manufacturing tolerance and/or post install drift due to thermal, vibrations, impacts, and other effects. The self-calibration can involve taking pictures from each camera and comparing against known reference for the amount of drift (e.g., deviation). As the drift changes, the system automatically adjusts the input images relative to known references by an appropriate amount to get back to the baseline images that rest of the pipeline expects. The amount of adjustment needed is used to assess the new and modified calibration parameters. Alternatively, the drift can be included as a variable in the stereo depth computation.

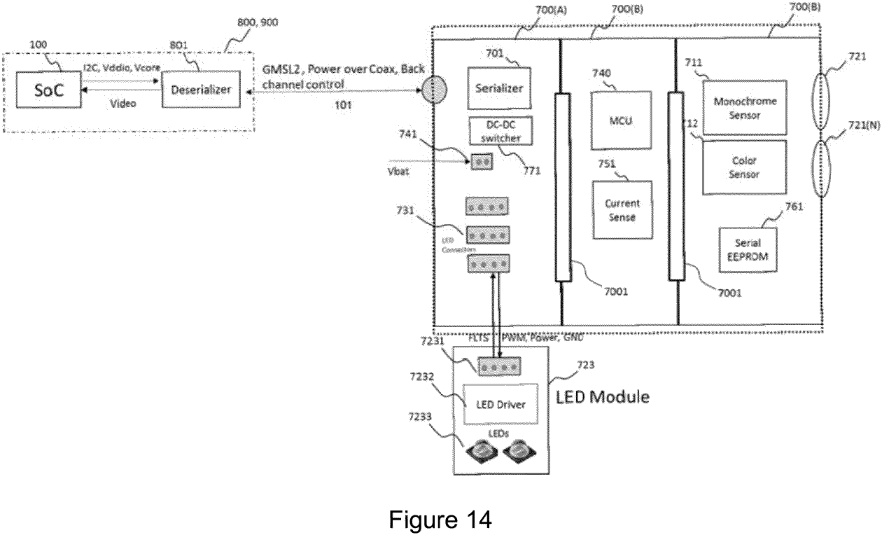

FIG. 14 illustrates another embodiment of a Camera Module Layout. Preferably the camera module (700) is mounted in a single housing, and on a single PCB. Alternatively, camera module (700) may comprise a plurality of boards (700A, 700B, 700C), coupled with board-to-board connectors (7001).

Camera module (700) is preferably coupled to the control platform (800, 900) via GMSL2. Camera module (700) preferably includes the following components: Serializer (701), DC-DC switcher (771), power from battery source (741), microcontroller (740), current sense (751), monochrome sensor (711), color sensor (712), LED connectors (731), and one or more lenses (721-721(N)).

In one embodiment, Serializer (701) is preferably a MAX9295A GMSL2 SER, though other Serializers may be used according to the invention. In one embodiment, MCU (740) is a Microchip/Atmel SAMD21, though other MCUs may be used. Many different camera lenses (721-721(N)) may be used according to the invention. In one embodiment, the camera lenses (721-721(N)) are LCE-C001 (55 HFoV) with 940 nm band pass.

In this embodiment, camera module (700) is preferably coupled to LED Module (723). The LED lens (7233) is preferably a Ledil Lisa2 FP13026. In other embodiments, other LED lenses may be used. LED Driver (7232) is preferably an ON-Semi NCV7691-D or equivalent, though other LED drivers may be used. Alternatively, LED Module may be integrated into housing of the Camera Module (700).

This embodiment preferably includes a self-calibration capability, as discussed in connection with FIG. 13. According to the embodiment, power and thermal requirements for the combined components must be satisfied by the single housing. The housing and cooling (which may be passive or active if needed) is designed for the max power input into the module and maximum operating ambient temperature expected.

FIG. 15 illustrates the LED and Flash control according to one embodiment of the invention. MCU (740) is coupled to the monochrome sensor (711), color sensor (712) current sense (751) and LED Drivers (7232). If the LEDs have a fault, LED Drivers (7232) send fault signal (FLTS) to MCU (740). This allows the controlling software to know of the fault and take appropriate action. For example, IR LEDs should not stay on beyond a prescribed period, especially for in-cabin applications, to mitigate the risk of eye dryness and discomfort. The system detects the failure of the LED control to turn the IR LED off at the specified duty cycle. MCU (740) preferably controls the LED Drivers (7232) using a Pulse Width Modulated (PWM) signal, with on/off pulses. The “on” or high pulse of the PWM signal keeps the LED on. The MCU controls how long and when LED turns on by changing the PWM signal’s pulse width.

LED Driver (7232) is preferably an ON-Semi NCV7691-D or equivalent, though other LED drivers may be used. In one embodiment, Current Sense device (751) is the Microchip PAC1710. Alternatively, other current sense devices may be used.

In one embodiment, MCU (740) disables the LED PWM signal upon receipt of the ALERT# signal. MCU (740) disables the LED PWM signal for a given LED upon the fault signal, FLTS. MCU (740) also provides for individual LED brightness control

The cameras and camera modules communicate with controllers (100(1)-(N)) via GMSL or FPDLink to an AVC board where a de-serializer converts it to CSI format which is then read by the Advanced SoCs (100). In conventional systems, camera data can be shared by two SoCs on the same board using dual outputs from the de-serializer but CSI cannot be communicated off-board.

It is desirable to be able to share camera data between multiple controllers (100), including one or more controllers used for autonomous driving (AV) functionality, and one or more controllers (100) used for the AI driver assistance (IX) functionality described herein. For example, camera data may advantageously be shared between one or more controller used for autonomous driving functionality (100(1)) and the Risk Assessment Modules (6000) of the present system, described herein without limitation. Similarly, systems with high-levels of autonomy require some amount of fail operation to achieve automotive safety rating ASIL D. This is accomplished using two platforms one acting as a primary and a second acting as a backup, as described in U.S. Application No. 62/584,549.

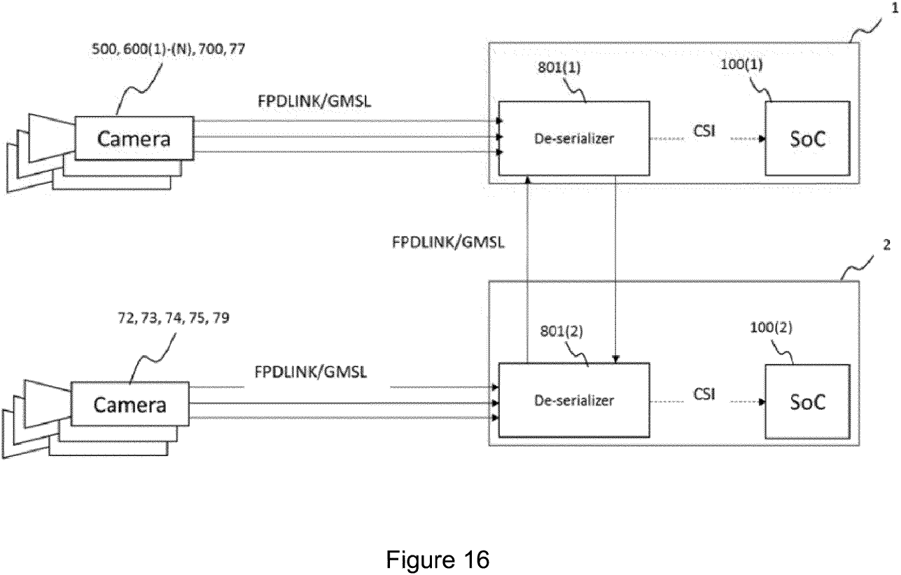

To avoid common cause failures due to physical location (e.g. vibration, water intrusion, rock strike) these units are separate boxes located in physically diverse locations. The desired configuration is shown, conceptually, in FIG. 16. To achieve this functionality, vehicle may include a sub-system for sharing camera data between controllers, as described in U.S. Application No. 62/629,822, filed Feb. 13, 2018, and incorporated by reference.

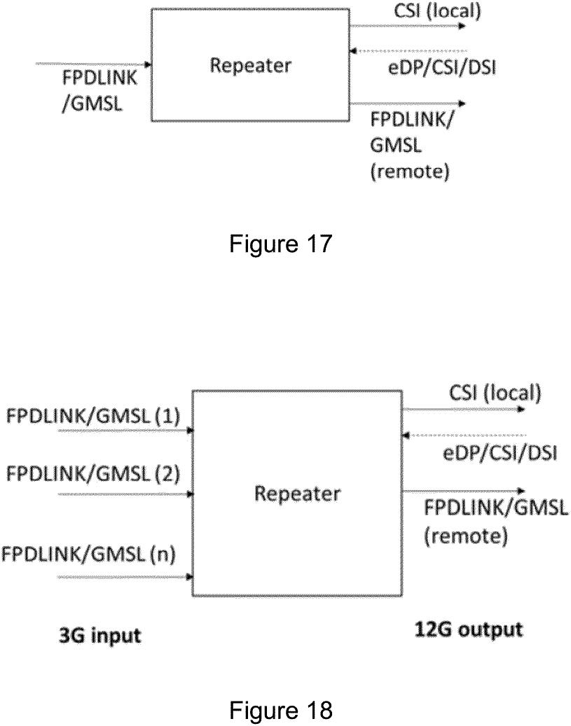

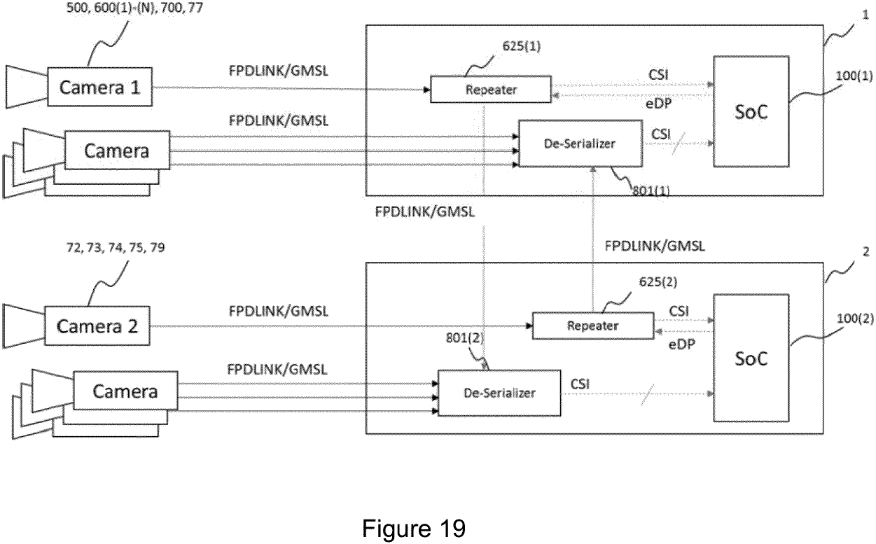

In one embodiment, the system includes one or more repeaters, which may be configured as illustrated in FIG. 17 or FIG. 18. Each repeater outputs both CSI and a pass-through of the FPDLINK/GMSL information. FIG. 19 shows an enhanced Repeater that takes inputs from multiple cameras and aggregates them into a single output higher data rate FPDLINK/GMSL output channel.

A block diagram using a Repeater of FIG. 18 is shown in FIG. 19, below. In this embodiment, MSCMs (500, 600(1)-(N), 700), and interior camera sensors (77(1)-(N)) provide input to platform (1), with SoC (100(1)). Platform (1) executes the IX stack, which provides for AI enhanced driver assistance as described herein. Exterior camera sensors (72, 73, 74, 75, 79) provide input to platform (2), with SoC (100(2)). Platform (2) executes the AV stack, which provides perception, planning, risk assessment, and autonomous driving functionality. Repeater (625(1)) enables camera information from one of cameras (500, 600(1)-(N), 700) to be shared with platform (2). Repeater (625(2)) enables camera information from one of camera sensors (72, 73, 74, 75, 79) to be shared with platform (1).

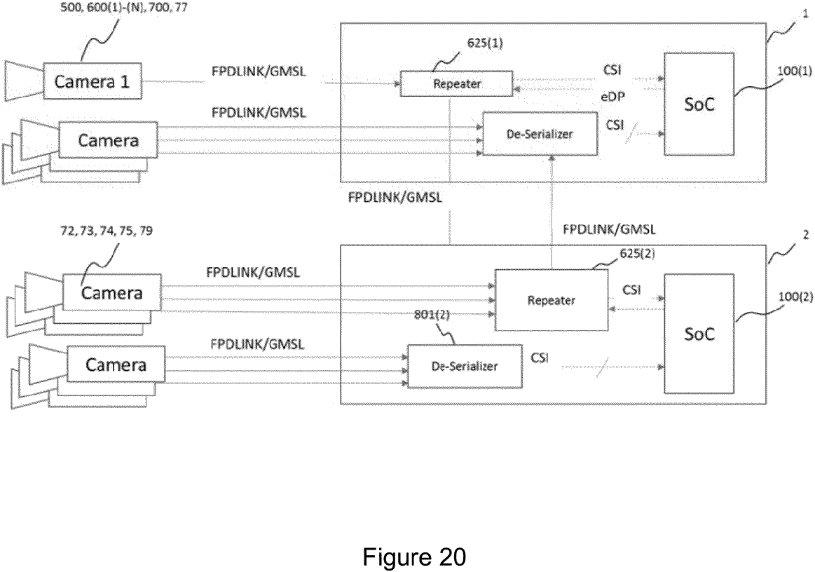

A second embodiment of the invention is shown in FIG. 20, using the repeater configuration with multiple inputs and a single aggregated output. In this embodiment, MSCMs (500, 600(1)-(N), 700), and interior camera sensors (77(1)-(N)) provide input to platform (1), with SoC (100(1)). Platform (1) executes the IX stack, which provides for AI enhanced driver assistance as described herein. Exterior camera sensors (72, 73, 74, 75, 79) provide input to platform (2), with SoC (100(2)). Platform (2) executes the AV stack, which provides perception, planning, risk assessment, and autonomous driving functionality. Repeater (625(1)) enables camera information from one or more of cameras (500, 600(1)-(N), 700) to be shared with platform (2). Repeater (625(2)) receives multiple inputs and provides a single CSI output. Thus, repeater (625(2)) enables camera information from one or more camera sensors (72, 73, 74, 75, 79) to be shared with platform (1).

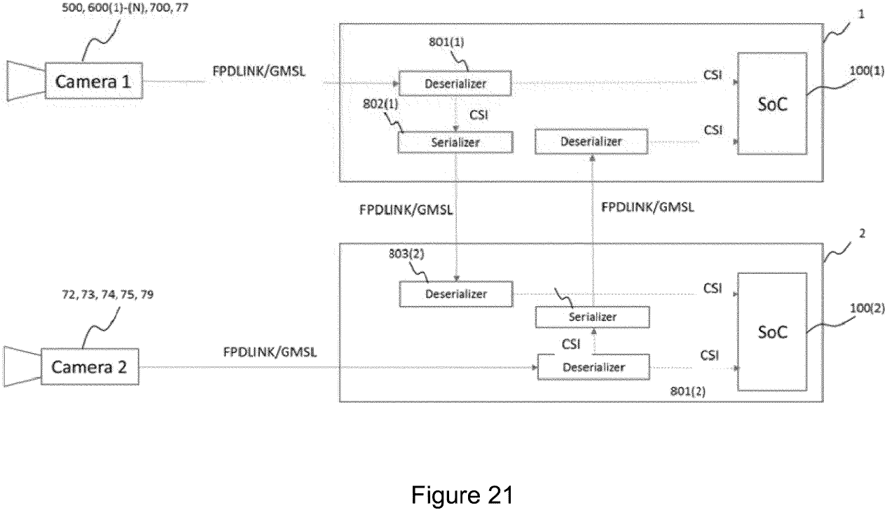

In another embodiment, shown below in FIG. 21, two de-serializers (801(1) and 801(2)) each output two CSI data streams in replicate mode are combined with a serializer to communicate off-board (802(1) and 802(2)). This has the advantage requiring no modifications to existing de-serializer designs available from both TI (FPD) and Maxim (GMSL).

The embodiments shown in FIG. 19 and FIG. 21 are preferable to other potential solutions. For example, another means for sharing camera data would include sharing data via a standard communications channel such as Ethernet. This has the problems that typical communication channels do not have enough bandwidth for camera frame data, also data needs to be received via CSI and then converted to Ethernet which can increase latencies and computer usage as well provided potential to lose content due to compression. Alternatively, a dual channel output from the camera could be used, but this solution increases board size within the camera causing cost and packaging issues.

Advanced AI-assisted vehicle (50) as illustrated in FIG. 1 and FIG. 2 include a plurality of cameras (72, 73, 74, 75, 76), capturing images around the entire periphery of the vehicle. Camera type and lens selection depends on the nature and type of function. Compared to sonar and RADAR, cameras generate a richer set of features at a fraction of the cost. The vehicle preferably has a mix of camera types and lenses to provide complete coverage around the vehicle; in general, narrow lenses do not have a wide field of view but can see farther. In one embodiment, the vehicle includes 12 cameras, although any greater or lesser number of cameras may be used. All camera locations on the vehicle preferably support a low-voltage, differential, serial interface and Gigabit Ethernet. In addition, camera data may be shared between multiple controllers in self-driving vehicles, as described in Application No. 62/629,822, (Attorney Docket No. 17-SC-0159-US01), filed Feb. 13, 2018.

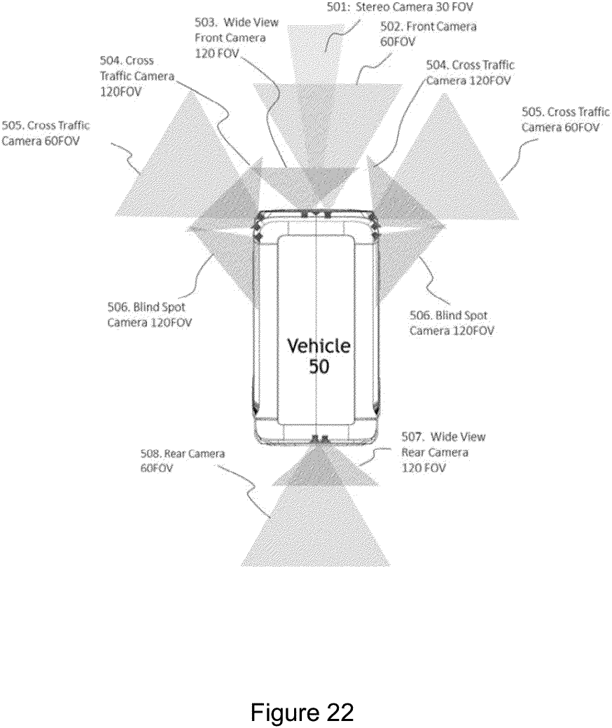

FIG. 22 illustrates one example of camera types and locations, with 11 cameras (501)-(508). Front-facing cameras (501)-(505) help identify forward facing paths and obstacles and provide information critical to making an occupancy grid and determining the preferred vehicle paths. Front-facing cameras may be used to perform many of the same functions as LIDAR, including emergency braking, pedestrian detection, and collision avoidance. Front-facing cameras may also be used for ADAS functions and systems including Lane Departure Warnings (“LDW”), and Autonomous Cruise Control (“ACC”), and other functions such as traffic sign recognition.

A variety of cameras may be used in a front-facing configuration, including, for example, the Bosch MPC2, a monocular camera platform that includes a CMOS (complementary metal oxide semiconductor) color imager with a resolution of 1280 × 960 pixels. The MPC2 include CAN, FlexRay and Ethernet interfaces.

Front-facing wide-view cameras (503)-(504) may be used to perceive objects coming into view from the periphery (e.g., pedestrians, crossing traffic or bicycles). In the embodiment shown in FIG. 22, front-facing wide-view cameras (503)-(504) are 2.3MP Cameras with a 120 degree field of view. Other Suitable cameras include the Sekonix SF3326-10X, which provides a horizontal FOV of 190 degrees and uses an Onsemi AR0231 image sensor. The camera provides 1928 × 1208 Resolution (2.3 M Pixel) in a 1/2.7-inch optical format, with a 27 MHz clock input, and uses a MAXIM MAX96705 Serializer. Other wide-view cameras and lenses may be used, as is known by persons of ordinary skill in the art.

In various embodiments, a long-view stereo camera pair (501) can be used for depth-based object detection, especially for objects for which a neural network has not yet been trained. Long-view stereo cameras (501) may also be used for object detection and classification, as well as basic object tracking. In the embodiment shown in FIG. 22, front-facing long-view camera (501) has a 30 degree field of view. Stereo cameras for automotive applications may be obtained from Continental, LG, Bosch, DENSO, Hitachi and Fujitsu Ten. For example, a suitable stereo camera includes the Conti Multi-Function Stereo Camera MFS430 or the Bosch Stereo Video Camera, with two CMOS color imagers with a resolution of 1280 × 960 pixels. The Bosch Stereo Video Camera is designed to records a horizontal range of 50 degrees and offer a 3-D measurement range of more than 50 meters; it is designed for ASIL-B. The Bosch unit includes an integrated control unit comprising one scalable processing unit, which provides a programmable logic (“FPGA”) and a dual core micro-processor with an integrated CAN or Ethernet interface on a single chip. The unit generates a precise 3-D map of the vehicle’s environment, including distance estimates for all the points in the image.

Similarly, the DENSO Compact Stereo Vision Sensor comprises two camera lenses (one each on the left and right) and an image processing chip. The DENSO Compact Stereo Vision Sensor measures the distance from the vehicle to the target object and is designed to activate the autonomous emergency braking and lane departure warning functions. Other stereo cameras may be used to practice the invention, as is known to persons of ordinary skill in the art. And other long-view cameras may be used, including monocular cameras.

Side or blind spot cameras (506) may be used for Surround View, providing information used to create and update the Occupancy Grid; as well as side impact collision warnings. In the embodiment shown in FIG. 22, blind spot cameras (506) are 2.3MP Cameras with a 120 degree field of view. In other embodiments, wide/fisheye view cameras are used, positioned on the vehicle’s front, rear, and sides. As illustrated in FIG. 2, the advanced AI-assisted vehicle may use three physical surround-only cameras (72) (Surround Left, Right, Rear) and leverage the physical Front Wide camera (73) as a logical fourth surround view camera. In other configurations, wing-mirror assemblies, when used, are typically custom 3-D printed so that the camera mounting plate matches the shape of the wing mirror (71). An example design includes the ClearView outside mirror by MAGNA, which integrates a camera into a traditional mirror and provides a larger field of view. Side cameras may also be placed in the four pillars at each corner of the cabin.

Rear cameras (507)-(508) may be used for park assistance, surround view, rear collision warnings, and creating and updating the Occupancy Grid. In the embodiment shown in FIG. 22, one rear camera (507) is a 2.3MP Cameras with a 120 degree field of view for shorter range detection, and another rear camera (508) is a 2.3MP Cameras with a 60 degree field of view for longer range detection. A wide variety of other cameras may be used, including, for example, the Bosch MPC2, which is also suitable as a front-facing camera. Rear camera may also be a stereo camera (74) of the type discussed above.

The camera types provided herein are examples provided without limitation. Almost any type of digital camera may be adapted for use with the invention. Alternate cameras include, for example, a Point Grey Grasshopper3 2.3 MP Color GigE Vision (Sony Pregius IMX174) or an On Semi AR0231 GMSL cameras manufactured by Sekonix. The GigE cameras can be any available type including 60 fps and global shutter. Preferably, the color filter pattern is RCCB, and Clear Pixel cameras are used to increase sensitivity. The invention can also include cameras installed to perform known ADAS functions as part of a redundant or fail-safe design, as discussed below. For example, a Conti Multi-Function Mono Camera, such as the MFC400, or MFC500, may be installed to provide functions including lane departure warning, traffic sign assist, and intelligent headlamp control.

In one embodiment, all cameras record and provide video information simultaneously. All cameras are preferably mounted in custom designed (3-D printed) assemblies to cut out not only stray light but also reflections from within the car, which may interfere with the camera’s data capture (since reflections from the dashboard reflected in the windshield mirrors is a major concern). Typical camera functional safety levels are ASIL B.

As illustrated in FIG. 2, the shuttle (50) may include one or more ultrasonic sensors (66). Ultrasonic sensors, positioned at the front, back, and even the sides, are most often used for park assist and to create and update an occupancy grid. However, the utility of sonar is both compromised at high speeds and, even at slow speeds, is limited to a working distance of about 2 meters. A wide variety of ultrasonic sensors may be used. Suitable ultrasonic sensors include, without limitation, the Bosch CA270 (designed for a 2.5 meter range) and Bosch CA271 (designed for a 4 meter range). The CA270 and CA271 stimulate an external transceiver and provide the reflected signal via 1-wire I/O interface to the ECU.

In certain embodiments, as illustrated in FIG. 2, the shuttle (50) may include one or more infrared or thermal cameras (75) to enhance the vehicle’s ability to detect, classify and identify objects, especially in the dark, and through fog or precipitation. The invention can include either an active infrared system or a passive infrared system. An active system uses an infrared light source to illuminate the area surrounding the vehicle with infrared light, using either a gated or non-gated approach. A gated active system uses a pulsed infrared light source and a synchronized infrared camera. Because an active system uses an infrared light source, it does not perform as well in detecting living objects such as pedestrians, bicyclists, and animals.

Passive infrared systems detect thermal radiation emitted by objects, using a thermographic camera. Passive infrared systems perform well at detecting living objects, but do not perform as well in especially warm weather. Passive systems generally provide images at less resolution than active infrared systems. Because infrared systems detect heat, they particularly enhance the vehicle’s ability to detect people and animals, making the vehicle more reliable and enhancing safety.

A wide variety of infrared sensors may be used with the invention. Suitable infrared systems include, without limitation, the FLIR Systems PathFindIR, a compact thermal imaging camera that creates a 320 × 240 pixel image with a 36 degree field of view, and an effective range of 300 m for people, and approximately twice that for larger, heat-emitting objects such as automobiles. The FLIR Systems PathFindIR II with a 320×240 thermal camera system and a 24° field of view, may also be used. For applications that require additional variations, including a zoom capability, the FLIR Systems Boson longwave infrared (“LWIR”) thermal camera cores may be used. Boson provides 640 × 512 or 320 × 256 pixel arrays, and supports 1X to 8X continuous zoom. Alternatively, especially for development vehicles, the FLIR ADK® may be used, built around the Boson core. The ADK’s thermal data ports provide analytics over a standard USB connection, or through an optional NVIDIA DRIVETM PX 2 connection.

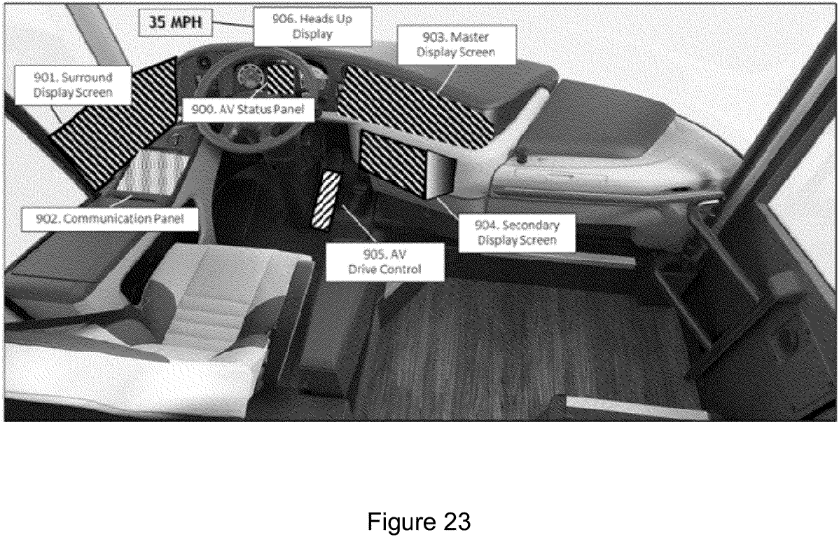

FIG. 23 illustrates one embodiment of the Driver UX input/output and configuration. Driver UX includes one or more display screens, including AV Status Panel (900), Master Display Screen (903), Secondary Display Screen (904), Surround Display Screen (901), and Communication Panel (902). AV Status Panel (900) preferably is a small (3.5″, 4″, or 5″) display showing only key information for the safety driver to operate the vehicle.

Surround Display Screen (901) and Secondary Display Screen (904) preferably display information from cross-traffic cameras (505), blind spot cameras (506), and rear cameras (507) and (508). In one embodiment, Surround Display Screen (901) and Secondary Display Screen (904) are arranged to wrap around the safety driver as illustrated in FIG. 23. In alternative embodiments, the display screens may be combined or arranged differently than the embodiment shown in in FIG. 23. For example, AV Status Panel (900) and Master Display Screen (903) may be consolidated in a single forward-facing panel. Alternatively, a part of Master Display Screen (903) may be used to show a split-screen view, or an overhead view of the advanced AI-assisted vehicle, with objects around it. Alternatively, Driver UX input/output may include a heads-up display (“HUD”) (906) of vehicle parameters such as speed, destination, ETA, and number of passengers, or simply the status of the AV system (activated or disabled).

The driver interface and displays may provide information from the autonomous driving stack to assist the driver. For example, the driver interface and displays may highlight lanes, cars, signs, pedestrians in either the master screen (903) or in HUD (906) on the windshield. The driver interface and displays may provide a recommended path that the autonomous driving stack proposes, as well as suggestions to cease accelerating or begin braking as the vehicle nears a light or traffic sign. The driver interface and displays may highlight points of interest, expand the view around the car when driving (wide FOV) or assist in parking (e.g., provide a top view - if the vehicle has a surround camera).

The driver interface and display preferably provide alerts including: (1) wait conditions ahead including intersections, construction zones, and toll booths, (2) objects in the driving path like a pedestrian moving much slower than the Advanced AI-Assisted Vehicle, (3) stalled vehicle ahead, (4) school zone ahead, (5) kids playing on the roadside, (6) animals (eg., deer or dogs) on roadside, (7) emergency vehicles (e.g., police, fire, medical van, or other vehicles with a siren), (8) vehicle likely to cut in front of driving path, (9) cross traffic, especially if likely to violate traffic lights or signs, (10) approaching cyclists, (11) unexpected objects on the road (e.g., tires and debris), and (12) poor-quality road ahead (e.g., icy road and potholes).

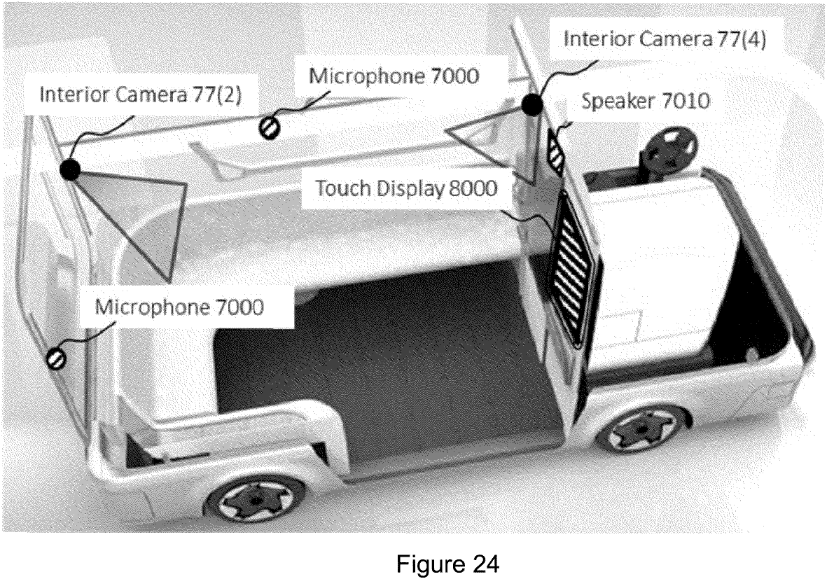

Embodiments can be suitable for any type of vehicle, including without limitation, coupes, sedans, buses, taxis, and shuttles. In one embodiment, the advanced AI-assisted vehicle includes a passenger interface for communicating with passengers, including map information, route information, text-to-speech interface, speech recognition, and external app integration (including integration with calendar applications such as Microsoft Outlook). FIG. 24 illustrates an exemplary interior according to one embodiment of the invention. Interior includes one or more interior cameras (77), one or more interior microphones (7000), and one or more speakers (7010) for communicating with travelers. Interior also preferably includes touch display (8000) for I/O.

In one embodiment, the shuttle interior includes an overhead display (preferably without touch capability) showing an overview map and current route progress. Such an overhead display preferably includes AV driving information of interest, such as bounding boxes, path, identification of object type, size, velocity, and the like. In this manner, overhead display reassures travelers that the shuttle perceives the world around it and is responding in a safe and appropriate manner. In one embodiment, overhead display is clearly visible for safety passengers

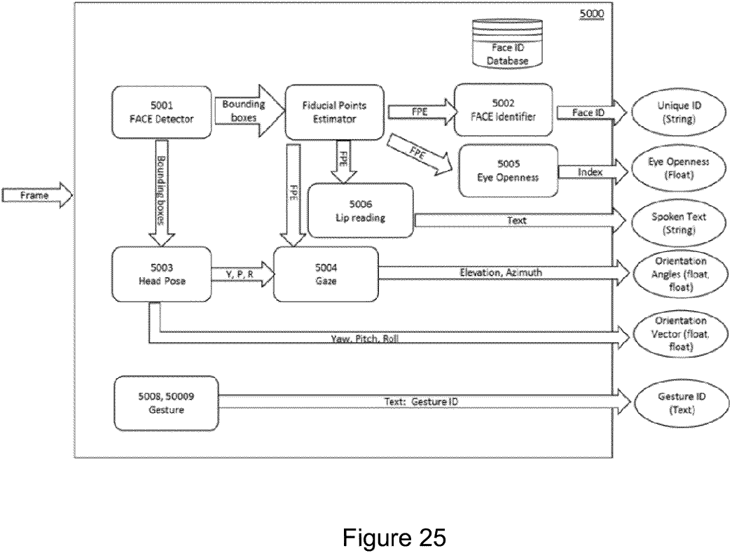

FIG. 25 illustrates one embodiment of a Deep Neural Network (DNN) pipeline suitable for the invention. Each frame is input into DNN pipeline (5000). Face detector (5001) is a DNN trained to identify the presence of a face and output bounding boxes. Head pose (5003) is a DNN trained to identify the pose of a head and output yaw, pitch, and roll angles. In one embodiment, head pose may be determined as described in U.S. Application No. 15/836,549 (Attorney Docket No. 17-SC-0012US01), filed Dec. 8, 2017, incorporated by reference.

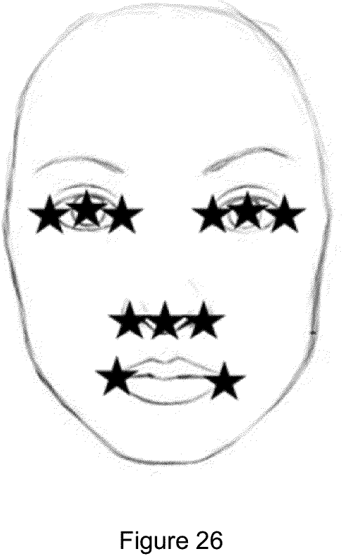

Fiducial points estimator (50011) (FPE) receives bounding box information from Face detector (5001) and provides FPE data to Face identifying DNN (5002), Eye openness DNN (5005), Lip reading DNN (5006), and gaze detection DNN (5004). Fiducial points are landmarks on a person’s face, as illustrated in FIG. 26.

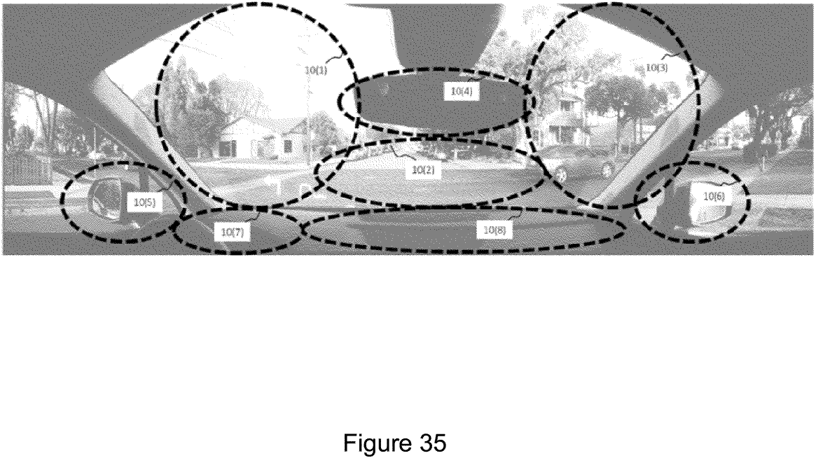

Face identifying DNN (5002) outputs a Unique ID representing the Face ID, corresponding to a face in the Face ID Database. Eye openness DNN (5005) outputs a value representing the eye openness. Lip reading DNN (5006) outputs a text string of spoken text. Gaze detection DNN (5004) receives the FPE from Fiducial Points Estimator (50011) as well as the yaw, pitch and roll from head pose DNN (5003) and outputs values representing the driver’s gaze. Gaze values may be angles measuring elevation and azimuth, or it may be a value representing the region that is the focus of the driver’s gaze, such as the regions illustrated in FIG. 35.

DNN pipeline (5000) preferably also includes DNNs trained to detect gestures of the driver and/or passengers (5008, 5009) such as a DNN to detect passenger conflict (5008) (preferred in vehicles such as taxis, buses, and shuttles) and driver distress (5009).

Conventional techniques for facial analysis in videos estimate facial properties for individual frames and then refine the estimates using temporal Bayesian filtering. Alternatively, in one embodiment, head pose may be determined as described in U.S. Application No. 15/836,549 (Attorney Docket No. 17-SC-0012US01), filed Dec. 8, 2017, incorporated by reference. According to the method described in U.S. Application No. 15/836,549, dynamic facial analysis in videos includes the steps of receiving video data representing a sequence of image frames including at least one head and extracting, by a neural network, spatial features comprising pitch, yaw, and roll angles of the at least one head from the video data. The method also includes the step of processing, by a recurrent neural network, the spatial features for two or more image frames in the sequence of image frames to produce head pose estimates for the at least one head.

According to one embodiment, the facial analysis system includes a neural network and recurrent neural network (RNN) for dynamic estimation and tracking of facial features in video image data. The facial analysis system receives color data (e.g., RGB component values), without depth, as an input and is trained using a large-scale synthetic dataset to estimate and track either head poses or three-dimensional (3D) positions of facial landmarks. In other words, the same facial analysis system may be trained for estimating and tracking either head poses or 3D facial landmarks. In the context of the following description a head pose estimate is defined by a pitch, yaw, and roll angle. In one embodiment, the neural network is a convolutional neural network (CNN). In one embodiment, the RNN is used for both estimation and tracking of facial features in videos. In contrast with conventional techniques for facial analysis of videos, the required parameters for tracking are learned automatically from training data. Additionally, the facial analysis system provides a holistic solution for both visual estimation and temporal tracking of diverse types of facial features from consecutive frames of video.

In one embodiment, emotion recognition, face identity verification, hand tracking, gesture recognition, and eye gaze tracking can be performed using landmark detection with semi-supervised learning, as described in U.S. Application No. 62/522,520, filed Jun. 20, 2017, incorporated herein by reference. In this embodiment, the model leverages auxiliary classification tasks and data, enhancing landmark localization by backpropagating classification errors through the landmark localization layers of the model. For example, one embodiment uses a sequential architecture, in which the first part of the network predicts landmarks via pixel-level heatmaps, maintaining high-resolution feature maps by omitting pooling layers and strided convolutions. The second part of the network computes class labels using predicted landmark locations. In this embodiment, to make the whole network differentiable, soft-argmax is used for extracting landmark locations from pixel-level predictions. Under this model, learning the landmark localizer is more directly influenced by the task of predicting class labels, allowing the classification task to enhance landmark localization learning.

In another embodiment, the system performs appearance-based gaze estimation, ocular fiducial point estimation, and eye region segmentation using a convolutional neural network (CNN). In this embodiment, the system performs appearance-based gaze estimation by performing the steps of receiving an image of an eye and head orientation and computing a gaze orientation based on the image of the eye and the head orientation. This method includes ocular fiducial point estimation including receiving the image of the eye and detecting fiducial points along boundaries of the eye, an iris, and a pupil. This embodiment also includes a method for eye region segmentation including steps of receiving the image of the eye and segmenting regions of the pupil, iris, sclera and skin surrounding the eye. This embodiment may be performed as described more fully in U.S. Application No. 62/439,870, filed Dec. 28, 2016, incorporated by reference. In one embodiment, the system tracks gaze on a 2D plane in front of the user.

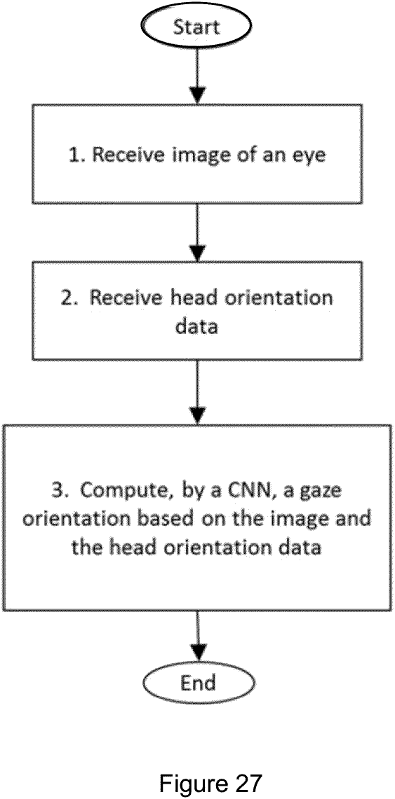

FIG. 27 illustrates a flowchart of a method for gaze estimation, in accordance with one embodiment. At step 1, an image of an eye is received. At step 2, head orientation is received. In one embodiment, the head orientation data is pre-computed and may include azimuth and elevation angles. In another embodiment, the head orientation data is an image of a subject’s face and the head orientation is determined based on the image. At step 3, a gaze position is computed by a CNN based on the image and the head orientation data.

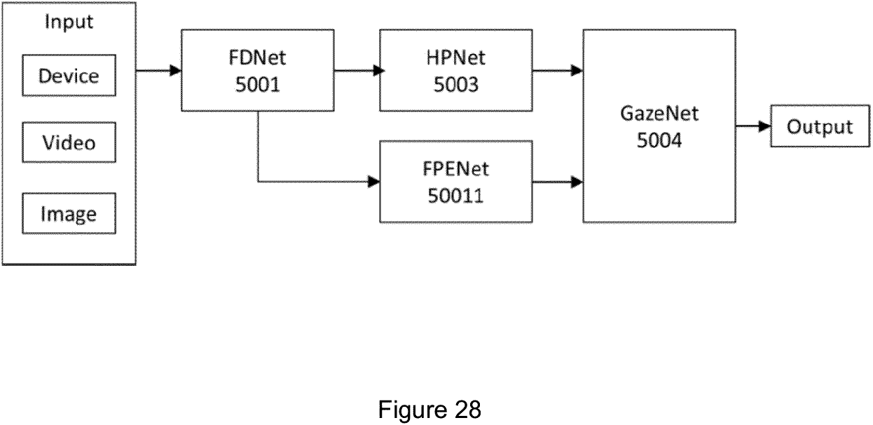

FIG. 28 illustrates a pipeline of neural networks suitable for determining Gaze Detection according to one embodiment. FDNet (5001) is trained to detect the presence of a face. HPNet (5003) determines the pose of the person’s head. FPENet (50011) detects the fiducial points. In this embodiment, GazeNet (5004) is a neural network is trained using inputs comprising both head position data (x. y, z) and the fiducial points associated with the head. Using these inputs, GazeNet detects the gaze of the driver.

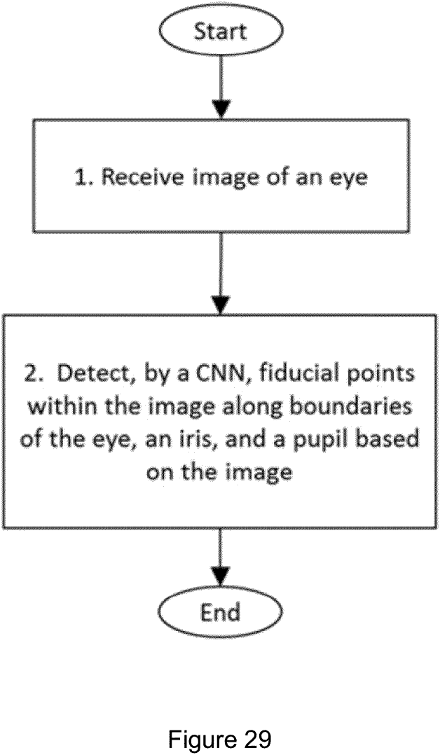

FIG. 29 illustrates a flowchart of a method for ocular fiducial point estimation, in accordance with one embodiment. At step 1, an image of an eye is received. At step 2, fiducial points along boundaries of the eye, an iris, and a pupil are detected by a CNN based on the image.

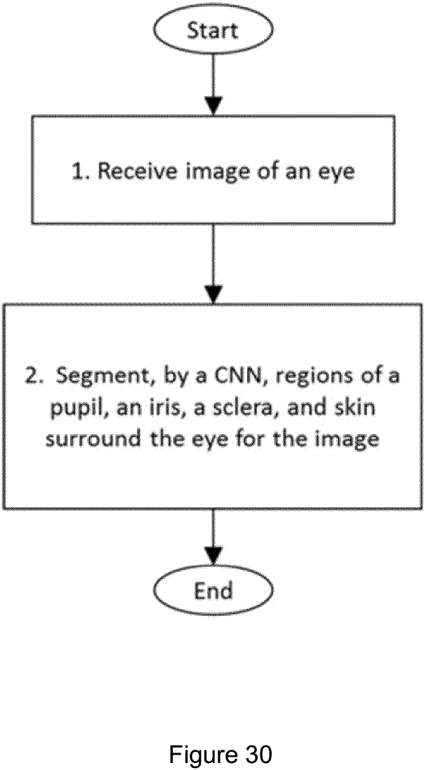

FIG. 30 illustrates a flowchart of a method for eye region segmentation, in accordance with one embodiment. At step 1, an image of an eye is received. At step 2, regions of a pupil, an iris, sclera, and skin surrounding the eye are segmented for the image by a CNN.

According to one embodiment of the invention, the system may perform optional variable rate inferencing (“VRI”). Neural networks (NN) take input and produce an inference output e.g. attributes such as, without limitation, face detection, fiducial points, emotions, gender, age, detected objects, person identification, etc. Neural networks, if left unchecked, can occupy most of the inferencing hardware and leads to inefficiency, particularly if the inferences are not always useful. For example, detecting age and gender of a subject is not necessary for every frame - nor is it necessary to continuously sweep a moving vehicle for weapons, contraband, and other objects. In this embodiment, on-demand variable rate inferencing may be performed by controlling the rate that images are fed into portions of the DNN pipeline, leading to more efficient use of the inferencing hardware, more efficient power consumption, and more responsiveness for critical inferencing tasks. Conventional solutions pass all the frames to the neural network without keeping the utilization in check, hindering with the performance of the system when multiple neural networks are running on the same system.

In various embodiments, the Advanced AI-Assisted Vehicle is capable of real-time camera calibration. Driver gaze estimation systems need to be continuously calibrated (computation of rotation from camera to the car coordinates.) Cameras move over time, and drivers tend to have unique anatomical structure and postures. According to embodiments, calibration occurs seamlessly in the background.

The approach consists of computing long term statistics (in the form of a histogram.) The dominant modes of this histogram correspond to the driver driving normally. Driving normally typically consists of looking at the middle of the current lane, approximately 100 meters in front of the car. And as the driver turns the system scan the driver’s gaze horizontally. These statistics can be computed robustly by long term aggregation. Normal driving can be favored by using the speed and steering of the car. When driving straight at 30 mph, the driver is driving normally. When stopped at 0 mph, the driver is not driving normally (and is more likely to be looking at cell phone, etc.) The long-term most dominant model provides 2 degrees of freedom. The dominant direction of variation (horizontal) provides 1 more. Together these provide the information needed to perform online calibration and to correct one or more of the pitch, yaw, and roll for the camera (either for the car or as a personalized estimate per driver.)

The camera calibration technique has several advantages. Calibration is seamless and runs continuously in the background, and the driver does not have to go through a calibration procedure. The approach is robust through long term averaging (temporary errors are ignored). In addition, estimates can be validated to not deviate beyond a threshold tolerance from the manufacturer specs. The computational load is very small and can easily run in the background and consists of incrementally Driver Settings Calibration.

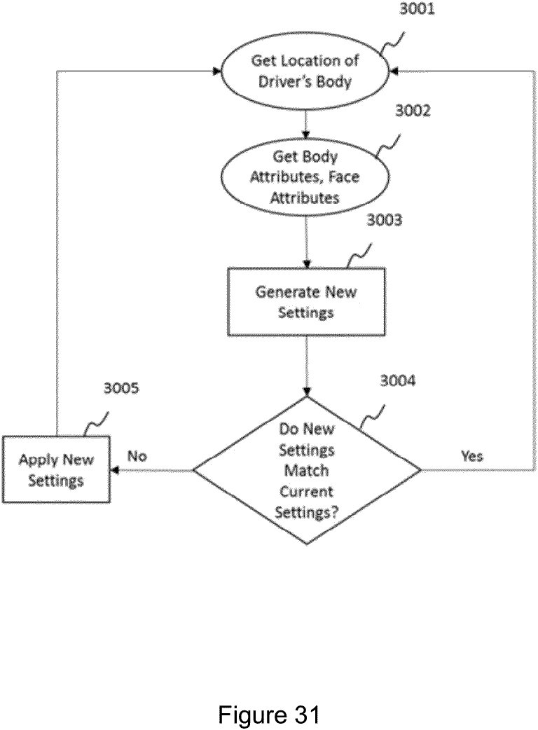

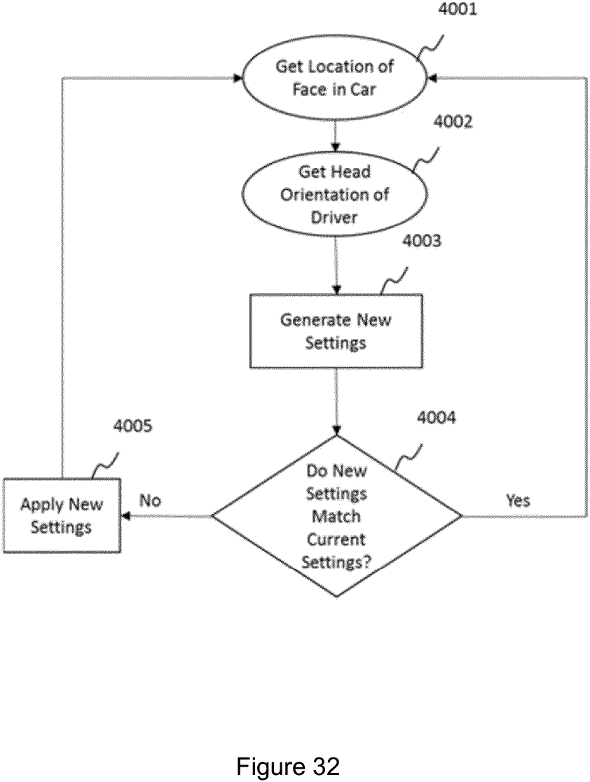

In various embodiments, the Advanced AI-Assisted Vehicle is also capable of real-time assessment of driver position and orientation and can use these to perform dynamic adjustment of settings and calibrations to provide improved safety and comfort. In certain embodiments, the system periodically determines driver body location, face attributes, and head orientation, using DNN pipeline and analysis techniques. As illustrated in FIG. 31 and FIG. 32, the system generates new settings and compares them to the current values, and if different updates the new settings accordingly. Parameters adjusted according to such embodiments can include identifying the display to use for warnings and notifications based on where the driver is looking at the time when such information is relevant; controlling brightness and content of displays to avoid distraction; improving the relevance of displayed content. For example, the brightness of screens the driver is not currently looking at can be reduced. Another example use case may be to reduce motion artifacts in screens in the peripheral vision of the driver to prevent unwarranted distraction.

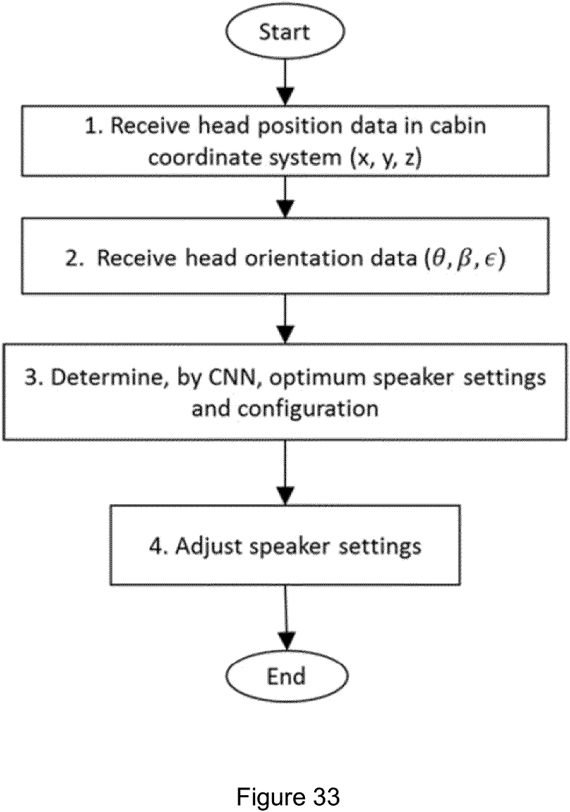

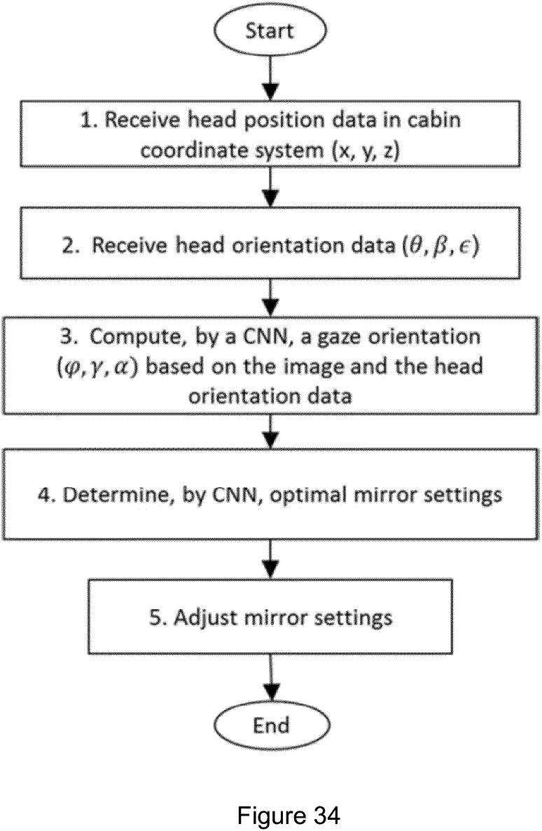

In various embodiments, the Advanced AI-Assisted Vehicle is also capable of real-time audio and mirror adjustment. For example, the audio system can change settings of equalization, bass, frequencies etc., based on the head pose of the user. For example, when the user’s head pose is looking towards the right the speakers and bass settings which are pointed towards the ears get activated to give a personalized audio experience. A DNN may be trained to determine the optimal settings and configuration and perform the changes. FIG. 33 illustrates the process for adjusting the audio settings. A similar process may be used to adjust the safety mirrors. FIG. 34 illustrates the process for adjusting the mirror settings.

In another embodiment, the system provides for real-time dimming of the mirror when the headlights of following cars would otherwise be blinding or uncomfortable to the driver. Using eye tracking and gaze detection as described above, the driver’s gaze is determined. Using the exterior rear-view cameras described above (507, 508), the system detects the presence of “high intensity” trailing vehicle lights. A DNN may be trained to dim the rear-view mirror, using LCD segments, when the trailing vehicle lights are deemed to exceed a high-intensity threshold and when the driver’s glances up at the mirror. In this way, the headlights remain bright until the driver glances up. This ensures that the driver is not blinded by the bright headlights but does not lead the driver into a false sense of security. Rather, when a vehicle is tailgating, the driver will sense the bright lights in the driver’s peripheral vision.

In another embodiment, setting and tracking of mirror settings can also be based on real-time monitoring of the driver’s head position, in addition to, or in lieu of, the driver’s gaze. In an example non-limiting embodiment, automatically adjusting a vehicle’s mirrors according to the driver’s head pose is performed using just a single Infra-Red (IR) camera by utilizing deep learning, computer vision and automatic control theory. This feature can automatically adjust both mirrors in both directions (pitch and yaw). It is also self-adjustable according to the driver’s head position preferences. According to such embodiments, an IR camera is mounted at the back of a steering wheel facing the driver, which captures the driver’s head movement. Advanced face analysis algorithms using deep learning and 3D face models are applied to calculate the driver’s 6 Degrees of Freedom (DoF) pose, i.e. yaw, pitch, and roll angles and 3D coordinates. A nonlinear optimization based control algorithm is used to apply the pose information and the vehicle 3D model to calculate a best mirror position for the driver’s current pose. Finally, the calculated adjustments time are actuated via (for example and without limitation) the step-motors of the mirrors in the vehicle.

As set forth above, driver monitoring and a DNN pipeline is used to monitor state of driver, e.g. gaze tracking, head pose tracking, drowsiness detection, sleepiness, eye openness, emotion detection, heart rate monitor, liveliness of driver, and driver impairment. To assist the driver, the system provides notification of potential hazards, advice, and warnings. When necessary for safety, the system is also configured to take corrective action, which may include controlling one or more vehicle subsystems, or when necessary, autonomously controlling the entire vehicle. The risk assessment module (6000), illustrated for example in FIG. 4 and FIG. 5, detects the state of the driver, assesses the risk of the current path, makes the appropriate notifications and warnings, and if necessary, engages in a self-driving mode.

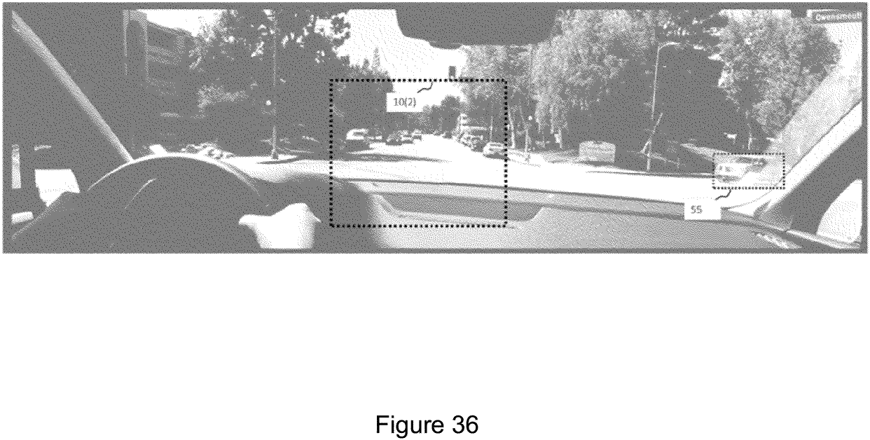

In one embodiment, risk assessment module (6000) determines whether cross-traffic is out of the driver’s field of view and provides appropriate warnings. FIG. 35 and FIG. 36 illustrate one scenario in which the risk assessment module (6000) uses information from a DNN for gaze detection (5004) and information from Controller (100) to alert driver.

The gaze detection DNN (5004) classifies the driver’s gaze as falling into a region, as illustrated in FIG. 35. In one example, the regions include left cross traffic (10(1)), center traffic (10(2)), right traffic (10(3)), rear-view mirror (10(4)), left side mirror (10(5)), right-side mirror (10(5)), instrument panel (10(7)), and center console (10(8)).

While gaze detection DNN (5004) classifies the region of the driver’s gaze, controller (100(2)) uses DNNs executing on an Advanced SoC to detect cross-traffic outside the driver’s field of view. Objects may be detected in a variety of ways, including, for example, the method for accurate real-time object detection and for determining confidence of object detection suitable for autonomous vehicles described in U.S. Application No. 62/631,781, filed Feb. 18, 2018 and incorporated by reference. FIG. 36 illustrates a scenario in which the gaze detection DNN (5004) detects that the driver’s gaze is directed at center traffic (10(2)), and Controller (100) detects cross-traffic (55).

Risk assessment module (6000) receives information regarding the region of the driver’s gaze and the approach of cross-traffic. Risk assessment module (6000) then determines whether the driver should be warned of the presence of the cross-traffic. In deciding whether to warn, the risk assessment module preferably considers several factors, including the speed and trajectory of the cross-traffic (55), the speed and trajectory of the Advanced AI-Assisted Vehicle (50), the state of any traffic control signs or signals, and the control inputs being provided by the driver.

For example, cross-traffic warnings are not necessary (and are even counterproductive) when the Advanced AI-Assisted Vehicle (50) is stopped at a red light. But cross-traffic warnings are helpful when the driver’s trajectory is on a potential collision course with cross-traffic.

Risk assessment module may use several different methods to determine whether a cross traffic warning is appropriate. For example, risk assessment module may use the method described in U.S. Application No. 62/625,351, which determines a safety buffer or “force field” based on the vehicle’s safety procedure. Alternatively, risk assessment module may use the method described in U.S. Application No. 62/628,831, which determines safety based on the safe time of arrival calculations. Both applications are incorporated by reference.

The risk assessment module may also use the method described in U.S. Application No. 62/622,538, which detects hazardous driving using machine learning. The application proposes the use of machine learning and deep neural networks (DNN) for a redundant and/or checking path e.g., for a rationality checker as part of functional safety for autonomous driving. The same technique may be extended for use with the risk assessment module (6000) to determine whether to activate the Drive AV or continue to sound the alarm. For example, the SafetyNet of U.S. Application No. 62/622,538 may be used to analyze the current course of action and generate a hazard level. If the hazard level is deemed to be too high, the risk assessment module (6000) of the present application may engage the Drive AV. Application No. 62/622,538 is hereby incorporated by reference.

The risk assessment module may also use other approaches to determine whether to engage Drive AV. For example, the risk assessment module may provide a cross-traffic warning whenever the time to arrival (TTA) in the path of the cross-traffic is a threshold time, e.g., two seconds. This threshold may vary depending on the speed of the vehicle, road conditions, or other variables. For example, the threshold duration may be two seconds for speeds up to 20 MPH, and one second for any greater speed. Alternatively, the threshold duration may be reduced or capped whenever the system detects hazardous road conditions such as wet roads, ice, or snow. Hazardous road conditions may be detected by DNN trained to detect such conditions.

When appropriate, risk assessment module (6000) sends a control signal to UI (1000) instructing the system to provide a warning or notification to driver. The warning or notification may be a visual warning on the console (1000), a warning on the heads-up-display (906), or both. The warning or notification may also include an audio warning through a speaker (7010), which may include an alarm, a spoken warning from speech engine (6500) (e.g., “warning, cross traffic approaching on right”), or both. In one embodiment, the driver may notify the risk assessment module (6000) that driver is aware of the hazard by using a spoken notification (e.g., “I see it”) which quiets the alarm.

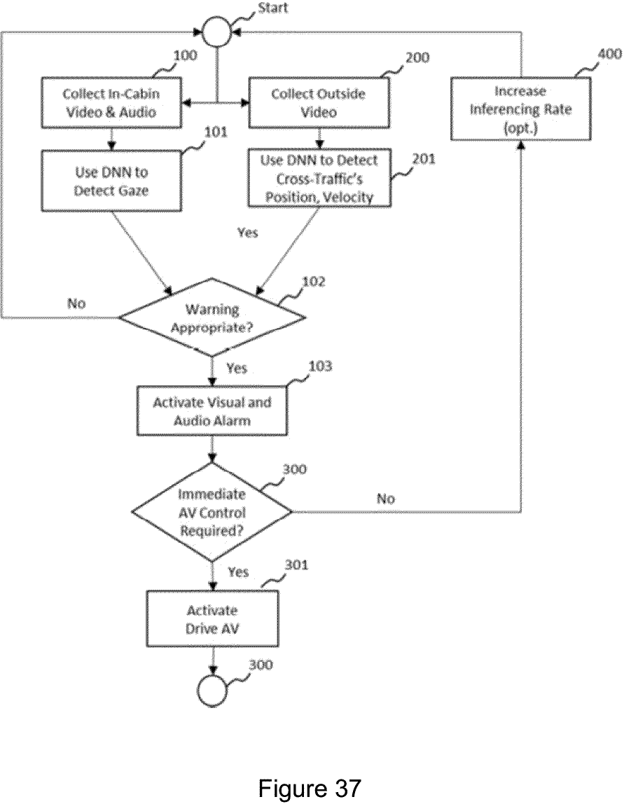

One embodiment of the process is illustrated in FIG. 37. In this embodiment, the system first uses a DNN to detect the driver’s gaze (101) and the presence, location, and velocity of cross-traffic (201). The system also determines, in step (301), whether immediate autonomous vehicle control is required. When the methods of either U.S. Application No. 62/625,351, U.S. Application No. 62/628,831, and/or U.S. Application No. 62/622,538 are used, the system may immediately activate autonomous vehicle control when, absent immediate corrective action, a collision would be imminent.

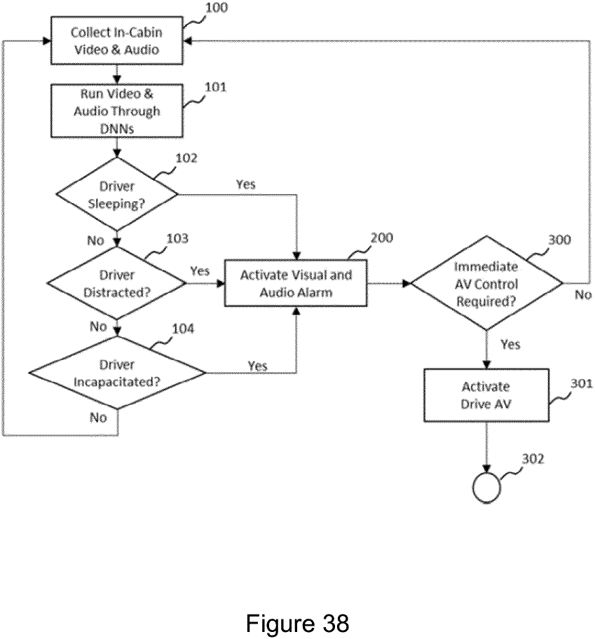

In another embodiment, illustrated in FIG. 38, risk assessment module (6000) determines whether the driver is impaired and takes appropriate action when impairment is determined. In the exemplary embodiment of FIG. 38, the risk assessment module (6000) receives input from the DNNs (5000) indicating the possible presence of any of three conditions: the driver is sleeping (102), the driver is distracted (103) and the driver is incapacitated (104).

According to the embodiment illustrated in FIG. 38, in-cabin audio and video data from cameras (77) and microphone (7000) is run through DNN pipeline (5000) in step (101). Risk assessment module (6000) determines the risk (i.e., likelihood) of the driver sleeping in step (102), using information from DNNs (5005) and/or (5003) regarding the driver’s eye openness and head pose. Risk assessment module (6000) determines the risk of the driver being distracted in step (103), using information from DNNs (5003), (5004), (5005) and/or (5006) regarding the driver’s head pose, gaze, eye openness, and/or eye obstructions. Risk assessment module (6000) determines the risk of the driver being incapacitated in step (104), using information from the same set of DNNs.

In one embodiment, determining whether the driver is distracted is calculated based on the driver’s Gaze. The world (field of view) in front of the driver is divided up in regions, as illustrated FIG. 35. Some of the regions are marked as distracted. Using the example illustrated in FIG. 35, Region 10(8) might be marked as distracted. Other regions, outside of the field of view shown in FIG. 35, would be marked as distracted. If the user does not look in the non-distracted region for certain amount of time, then he/she is distracted.

In other embodiment, driver drowsiness is determined using eye openness DNN (5005) in DNN pipeline (5000), to determine the percentage of eye closure (PERCLOS) measurement of Eye openness to detect whether the driver is drowsy or awake. In general, PERCLOS is defined as the measurement of the percentage of time the pupils of the eyes are 80% or more occluded. The pipeline must be able to function when the driver is wearing clear glasses, sunglasses, or has only one eye. The use of RGB, IR, and the 940 nm IR filter together provides robust performance against most sunglasses.

If the Risk assessment module (6000) determines that the driver is sleeping, distracted, and/or incapacitated, the system (9000) activates a visual and/or audio alarm in step (200). The warning or notification may also include an audio warning through speaker (7010), which may include an alarm, a spoken warning from speech engine (6500) (e.g., “warning-please stay alert”), or both.

In step (300), risk assessment module (6000) then makes an assessment as to whether immediate AV control is required. In one embodiment, the assessment considers the speed and trajectory of the vehicle, the condition of other traffic, the duration of time of the condition identified in steps (102)-(104), and the response of the driver to the alarm or notification activated in step (200). In determining whether and when to take control over the vehicle from the driver, the risk assessment module (6000) may use the procedures described in U.S. Provisional Application No. 62/625,351, filed Feb. 2, 2018, and U.S. Provisional Application No. 62/628,831, filed Feb. 9, 2018, both of which are incorporated by reference. For example, the risk assessment module (6000) may use the safe time of arrival methods set forth in Provisional Application No. 62/628,831 to test whether the present trajectory is still safe, and if it is, continue the alarm prior to assuming control over the vehicle.

If the risk assessment module (6000) determines that immediate control over the vehicle is not required, the process returns to step (100), but the alarm remains active. At any point in the process, the driver may notify the risk assessment module (6000) that driver is no longer compromised by using a spoken notification (e.g., “Thank you” or “I am awake”) which quiets the alarm.

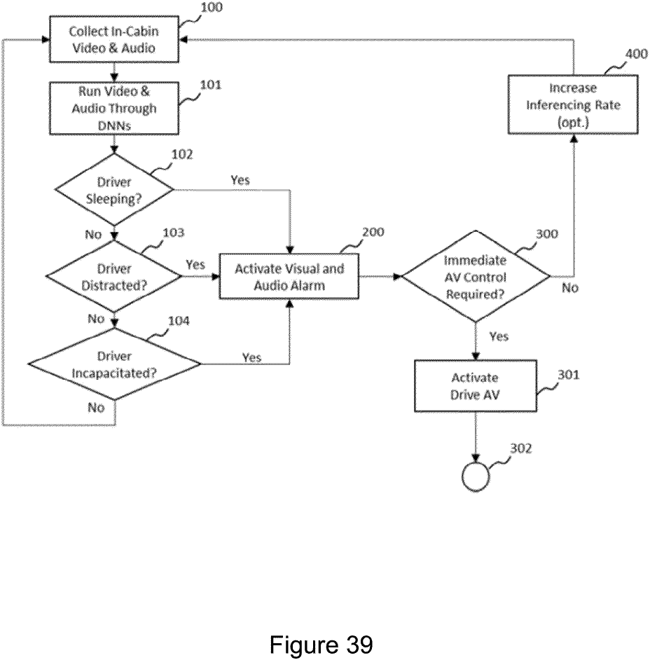

FIG. 39, below illustrates one embodiment of the risk assessment flow, using optional variable rate inferencing (“VRI”). In FIG. 39, the risk assessment module increases the inferencing rate at step (400), after concluding that a potentially dangerous condition exists (102, 103, 104) and optionally providing a notification to the driver (200). The higher inferencing rate is justified due to the existence of the potentially dangerous condition. In this case, power and thermal concerns are no longer a reason to have a lower inferencing rate. Alternatively, VRI allows the system to monitor a large set of inputs and potential conditions and prioritize detected threads for more frequent inference.

According to the embodiment shown in FIG. 4, risk assessment module (6000) receives output from DNNs (5000) indicating the conditions of the driver and/or passengers. Risk assessment module (6000) also receives information from Controller (100(2)) regarding objects outside the vehicle, including their presence and trajectory to the risk assessment module (6000). Risk assessment module (6000) performs a risk assessment analysis to determine the presence and level of risk, and what remedial steps to take. Risk assessment module may also receive information from one or more ADAS sub-systems (28), including Blind Spot Warning (BSW), Automatic Emergency Braking (AEB), Lane Departure Warning (LDW), Emergency Brake Assist (EBA), and Forward Crash Warning (FCW) systems.

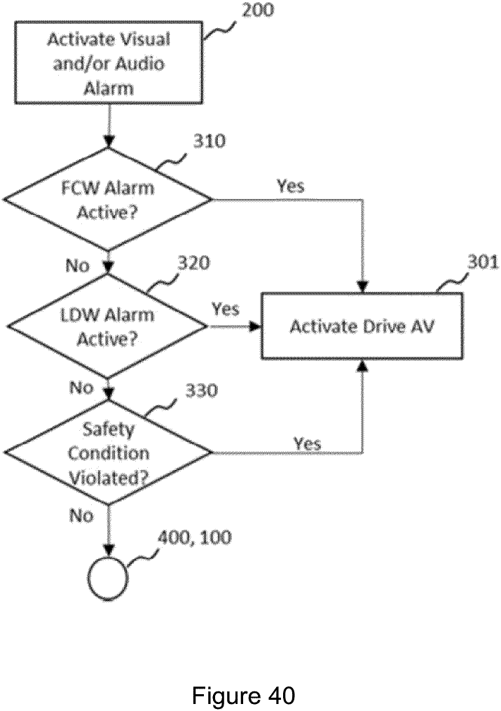

FIG. 40 illustrates one example of a process that may be followed by the risk assessment module (6000) to determine whether to activate the autonomous driving system. At step (200), the system has detected an impaired or compromised driver and activated visual and/or audio alarm. In one embodiment, when an ADAS system is present, risk assessment module (6000) will activate the autonomous driving system if the ADAS system indicates an alarm (310, 320).

At step (330), if ADAS system is not present or has not indicated an alarm, risk assessment module (6000) determines whether a safety condition has been violated. Risk assessment module may use different tests to determine whether a safety condition has been violated.

For example, risk assessment module may use the method described in U.S. Application No. 62/625,351, which determines a safety force field based on the vehicle’s safety procedure. Alternatively, risk assessment module may use the method described in U.S. Application No. 62/628,831, which determines safety based on the safe time of arrival calculations. Both applications are incorporated by reference. U.S. Application Nos. 62/625,351 and 62/628,831 are hereby incorporated by reference.

Alternatively, risk assessment module may determine that a safety condition has been violated whenever the driver has been distracted, asleep, or incapacitated for more than a threshold duration (e.g., two seconds). The threshold may vary depending on the speed of the vehicle, road conditions, or other variables. For example, the threshold duration may be two seconds for speeds up to 20 MPH, and one second for any greater speed. Alternatively, the threshold duration may be reduced or capped whenever the system detects hazardous road conditions such as wet roads, ice, or snow. Hazardous road conditions may be detected by DNN trained to detect such conditions.

In one embodiment, the risk assessment module (6000) determines the likely intent of pedestrians, including their intent to move, their direction of travel, and their attentiveness. The system may use DNN pipeline (5000) which may include DNNs trained to (1) identify and detect policemen, firemen, and crossing guards, (2) identify and understand traffic control gestures from police/firemen, (3) understand hand signals from bicycle and motorcyclists, (4) understand pedestrian gestures such as hailing, asking a vehicle to halt, and others.

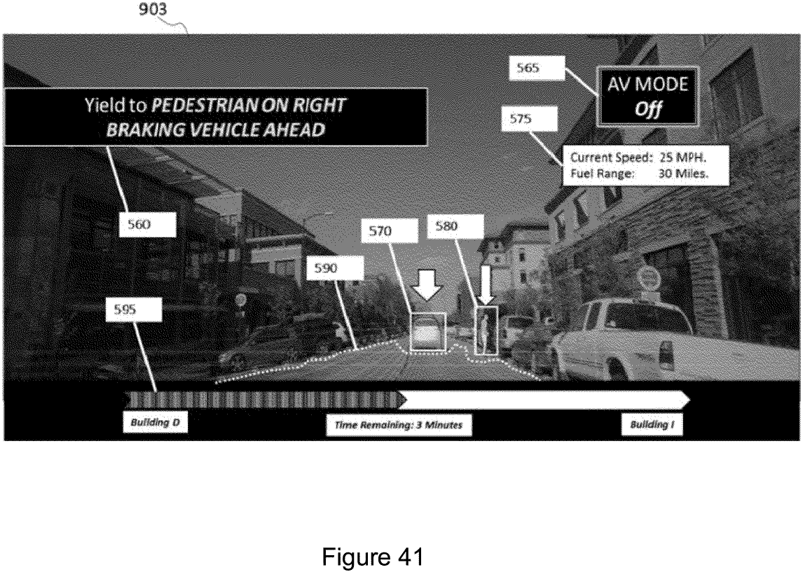

In another embodiment, risk assessment module (6000) determines whether a cyclist is approaching the vehicle and gives appropriate warnings. FIG. 41 illustrates the master display screen (903) according to one embodiment. Master display screen preferably displays a real-time view from the forward camera (903), as well as Advanced AI-Assisted Vehicle parameters (575) such as speed, destination, ETA, and number of passengers. ETA may be displayed as a progress bar, as illustrated in FIG. 41, or by a clock, digital readout or similar display. Master display screen (903) may include AV Mode Status indicator (565). Master display preferably provides feedback regarding the performance of the autonomous AV system, including a map of drivable free space (590) and bounding boxes around vehicles (570), pedestrians (580), and any other objects of interest. In one embodiment, the drivable free space (590) may be determined as described in U.S. Application No. 62/643,665.

These indicators inform safety driver that even if not engaged, the AV is correctly identifying road hazards, vehicles, and other objects. Master display preferably also includes an Alert Display (560), which highlights the presence of significant obstacles and informs the driver of the vehicle’s perception and warns the driver to respond to them. In the example illustrated in in FIG. 41, the Alert Display (560) warns the driver to “Yield to PEDESTRIAN ON RIGHT’ and warns the driver of “BRAKING VEHICLE AHEAD”. These alerts, combined with the free space (590) and bounding boxes around vehicles (570), pedestrians (580) give driver confidence and an appropriate warning. Alternatively, Alert Display (560) may be displayed as a heads-up display on the front windshield.

In one embodiment, when the risk assessment module (6000) determines the presence of a pedestrian that is outside the region of the driver’s persistent gaze, Alert Display (560) will provide an additional alert to notify the driver of the presence of the pedestrian. This alert may be in the form of a highlighted bounding box, larger written warning, or even an audible tone. The risk assessment module’s (6000) decision to provide that additional alert may be based, in part, on the pedestrian’s inferred intent. For example, if the pedestrian is making a gesture or indicating an intent to cross the street in front of the vehicle, the risk assessment module (6000) may activate the additional alert. This intent is inferred by use of trained DNNs, which are trained to recognize gestures, pedestrian pose/orientation, pedestrian attentiveness (i.e., warnings are more appropriate when a pedestrian is staring at a cellular device and not checking for traffic), pedestrian age and activity (children playing with a ball are more likely to dart into traffic), and pedestrian path/velocity. On the other hand, the additional alert is less necessary when the pedestrian is outside the path of the vehicle and expressing a clear intent to move even further out of the path-such as heading towards the sidewalk.

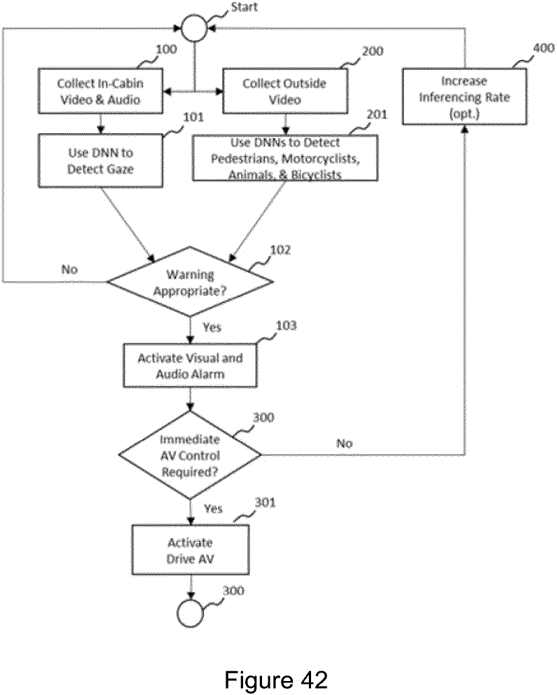

One embodiment of the process is illustrated in FIG. 42. In this embodiment, the system first uses a DNN to detect the driver’s gaze (101) and the presence, location, and velocity of pedestrians, cyclists, animals, and other vehicles (201). The system also determines, in step (301), whether immediate autonomous vehicle control is required. When the methods of either U.S. Application No. 62/625,351, U.S. Application No. 62/628,831, and/or U.S. Application No. 62/622,538 are used, the system may immediately activate autonomous vehicle control when, absent immediate corrective action, a collision would be imminent.

Other embodiments of the process extend control of vehicle functions based on the driver’s gaze. After the driver’s gaze is determined (e.g., using one or more DNNs as described above), certain car functions may be enabled or disabled. These functions can include, without limitation, automatically turning on (or off) or shaping a vehicle’s headlights, turning on or off cabin lights, turning on or brightening (or turning off and dimming) the vehicle’s interior display or portions of the display, and other operations to save power or ensure the driver has optimal illumination at all times. The brightness of one or more displays (e.g., dashboard, multi-media display) can be managed based on the location of the driver’s gaze.

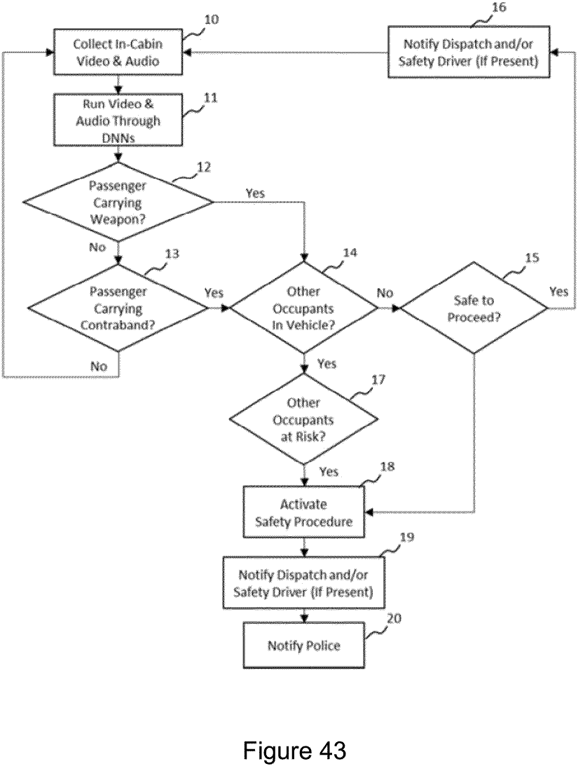

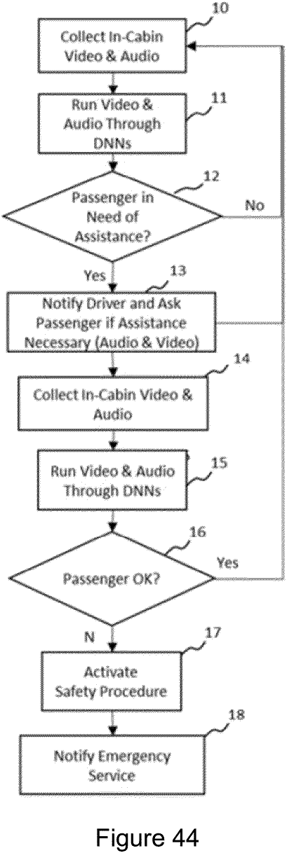

In another embodiment, risk assessment module (6000) determines whether a passenger has a dangerous or potentially dangerous object and takes appropriate action. In cases in which the vehicle operator would like to know whether a passenger is carrying something objectionable, such as guns or alcohol, the system uses a DNN to determine the presence of such object and provide appropriate notifications and/or warnings. In a driverless robo-taxi or shuttle the system may provide notification to a fleet operator and/or police. In a vehicle with a safety driver, the system may also notify safety driver in a discrete manner, as well as notify any fleet operator and/or police. FIG. 43 illustrates one flow embodiment of the passenger danger detection and warning.

In step (10), system collects in-cabin video and audio. In step (11), the system runs the video and audio through DNN pipeline. In step (12), the DNN determines whether a passenger is carrying a weapon. Weapons detected may include knives, firearms, and items that may be used as blunt force weapons. If the passenger is carrying a weapon, the system identifies the weapon and in step (14) uses a DNN to determine whether other occupants are in the vehicle. If other occupants are not in the vehicle, the system proceeds to step (15) and determines whether it is safe for the vehicle to proceed on its current route. This determination may take several different forms. For example, if the DNN detects a firearm and the current route is a school, government building, or other gathering place where firearms are prohibited, the system may determine that it is not safe to proceed and will move to step (18). Before activating safety procedure in step (18), the system preferably executes another DNN to identify the passenger possessing the weapon. For example, if the DNNs identify a passenger carrying a firearm, another DNN will seek to identify the passenger carrying the firearm to determine whether that passenger is authorized to carry it, such as an authorized law enforcement officer. If the DNN detects a firearm and the current route is to an authorized rifle range or shooting range, absent other indicators of non-safety the system will determine that it is safe to proceed and will move to step (16). Similarly, if the DNN detects a baseball bat and the current route is to a baseball or softball field, system may, absent other indicators of non-safety the system will determine that it is safe to proceed and will move to step (16). Likewise, if the DNN detects a baseball bat and passenger holding the bat is a child wearing a baseball hat or with a glove, system may, absent other indicators of non-safety the system will determine that it is safe to proceed and will move to step (16). DNN may be trained to distinguish between dangerous conditions and passengers, with care taken to ensure that the DNN is not trained in such a manner to include inherent bias against any class.

In step (16), if the current route is deemed safe to proceed, system notifies dispatch and/or the safety driver, if present. This notification is not an alarm per se, but rather a notification that the dispatch and/or safety driver should confirm that it is safe for vehicle to proceed.

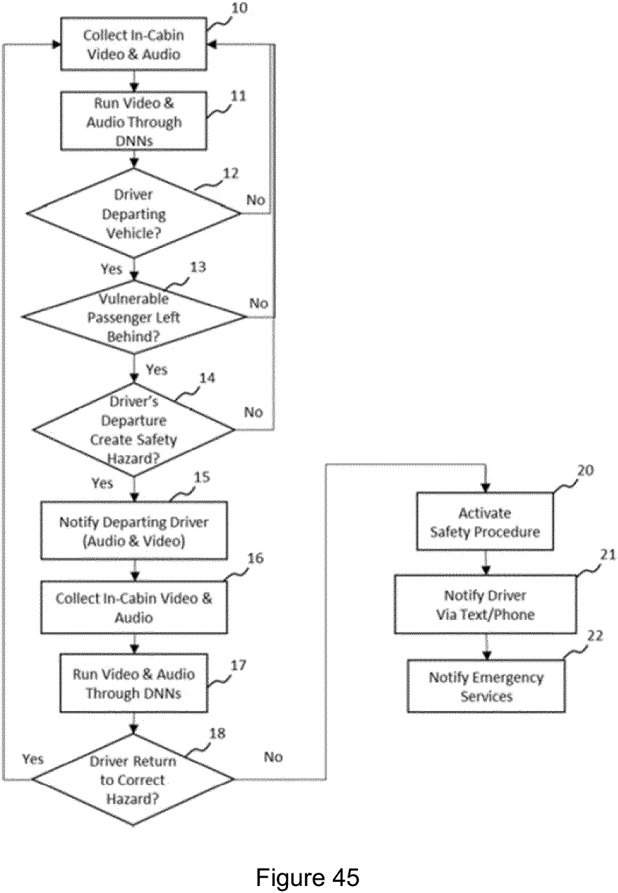

In another embodiment, risk assessment module (6000) determines whether a passenger requires assistance and takes appropriate action. FIG. 45 illustrates one embodiment of an analysis for passenger in need of assistance. In step (10), system collects in-cabin video and audio. The system runs the video and audio through DNNs (11) to identify whether the passenger needs assistance (12). Whether a passenger needs assistance may be detected by DNN, trained to identify injuries and infer whether a passenger may be having a heart attack or a stroke. For example, the warning signs for a stroke include face drooping. DNN may be trained to detect whether one side of a passenger’s face is drooping.

In step (13), system notifies the driver and asks the passenger if assistance is necessary. System may be trained to conduct a simple interview to help assess the presence of a medical condition. For example, speech difficulty is a symptom of stroke. System may ask the passenger to repeat a simple sentence and look for any speech abnormality.

In steps (14)-(16), the system collects additional video and audio information and feeds that information through the DNN pipeline. The trained DNN assesses whether the passenger is, in fact, in need of assistance. If the DNN concludes that the passenger is, in fact, in need of assistance, system activates safety procedure (17) which includes lowering the windows and turning the engine on to adjust the climate to a safe condition. In this mode, the car will not drive. Upon activating the safety procedure, the system notifies the driver by text or automated phone call (21), if the driver’s phone number is on file. If the driver does not return to correct the problem within a set time, the system notifies emergency services by text or automated phone call (22).

In another embodiment, risk assessment module (6000) determines whether a vulnerable passenger is in danger and takes appropriate action. Children and pets are sometimes unintentionally left in a locked car when a driver leaves the vehicle. In this embodiment, Controller (100(1)) uses the interior cameras MSCMs (500, 600(1)-(N), 700), and interior camera sensors (77(1)-(N)) can be used to detect the presence of passengers or pets.

FIG. 45 illustrates one embodiment of an analysis for vulnerable passenger safety. In step (10), system collects in-cabin video and audio. The system runs the video and audio through DNNs (11) to identify whether the driver is leaving the vehicle (12), the presence of vulnerable passengers left behind (13), and whether the driver’s departure will create a safety hazard (14). Driver departure may be detected by DNN, and vulnerable passengers left behind may also be determined by DNN, trained to identify toddlers, babies, young children, and pets. In step (14), the system also may use a DNN to determine the presence of a safety hazard. The trained DNN in step (14) may receive inputs such as images of the windows, the temperature inside the vehicle (from a thermometer located inside the car), the temperature outside the car (from a thermometer located inside the car), and the lighting (bright sun, overcast) outside the car. The DNN in step (14) trained to identify the presence of a safety hazard - for example, windows rolled up on a sunny day. After detecting a safety hazard, system notifies the departing driver preferably with audio and video warnings and monitors to determine whether the driver returned to the vehicle. If not, the system activates safety procedure (20) which includes lowering the windows and turning the engine on to adjust the climate to a safe condition. In this mode, the car will not drive. Upon activating the safety procedure, the system notifies the driver by text or automated phone call (21), if the driver’s phone number is on file. If the driver does not return to correct the problem within a set time, the system notifies emergency services by text or automated phone call (22).

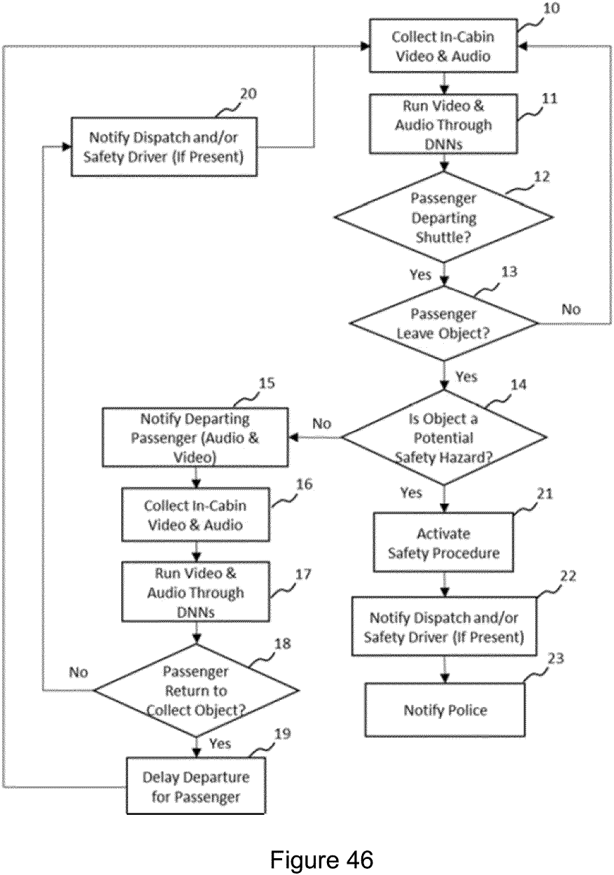

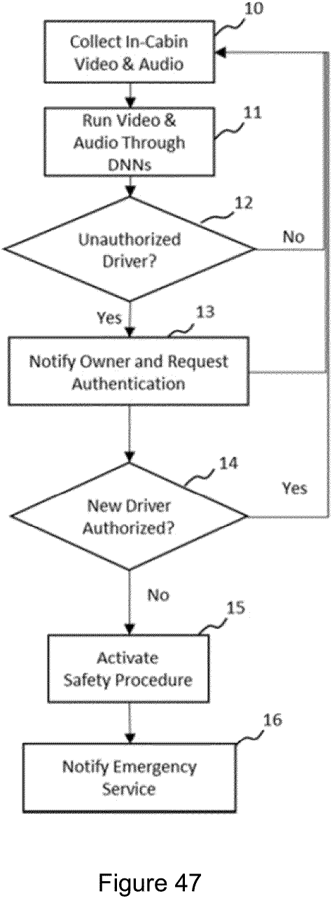

In another embodiment, risk assessment module (6000) determines whether a passenger is leaving an item of obvious value (purse, wallet, laptop computer) in plain view and provides a notification. If the passenger leaves a dangerous item (e.g., gun, knife) DNN pipeline identifies the item and risk assessment module (6000) determines the appropriate course of action. FIG. 46 illustrates a process for assessing a passenger’s left items.

In another embodiment, risk assessment module (6000) determines whether the vehicle has been turned over to an unauthorized driver. Risk assessment module (6000) can thus disable the vehicle in the case of theft or carjacking. The risk assessment module (6000) can also disable the vehicle in other circumstances to present unauthorized use. For example, vehicle owner may authorize one person (the owner’s child) to drive the vehicle, on the strict condition that no other person drives the vehicle. If the child attempts to turn over control of the car to an unauthorized friend, the risk assessment module (6000) detects the face of the new driver, determines that the new driver is unauthorized, and prevents the vehicle from driving. Risk assessment module (6000) may further send a text or notification to the vehicle’s owner, indicating that the new person in the driver’s seat is requesting permission to drive the car. The vehicle’s owner may either accept the request or reject the request via a user interface displayed by a mobile device, for example. In this way, the vehicle has a form of two-factor authentication. One example of the risk assessment process for unauthorized driver is illustrated below. In determining whether a driver or passenger is authorized, risk assessment module (6000) may use images from cameras exterior to the AI-assisted vehicle, or cameras on the inside of the cabin.

In other embodiments, the system provides for remote third parties to request access to the car. These embodiments allow a maintenance tech (auto repair), friend, family member or colleague to request access to the car. The remote party may request access either through a remote Android, iOS, or Blackberry app running on the remote third party’s phone, or through an app running in the AI assisted vehicle.

Using the cameras inside the cabin (or the camera on the requester’s cell phone) the system takes a photo or video and sends a notification to the vehicle’s owner requesting permission. The system allows the owner to reject, accept, or accept with conditions. For example, the system allows the vehicle owner to set limits such as: (1) miles authorized, (2) region authorized (geo-fencing), (3) speed limits, (4) duration of approval, (5) authorized time windows (e.g., daytime only), and others. The information, including restrictions, is transmitted to the vehicle which is authorizes the temporary user is authorized as such. If a driver attempts to exceed the authorization grant, the Advanced AI-Assisted Vehicle must determine a safe process to notify the owner and enforce the grant limitations. Risk Assessment Module (6000) performs this function. For example, if a driver attempts to enter a freeway on-ramp and is prohibited from entering the freeway (either due to road restrictions or geo-fence restrictions) the Advanced AI-Assisted Vehicle’s Risk Assessment Module (6000) may pass control to the autonomous driving controller (Drive AV) which in one embodiment would perform a safety procedure (e.g., pulling to the side of the road) and provide a notification to the driver.

In other embodiments, the Advanced AI-Assisted Vehicle may include a valet mode, initiated via voice request by an authorized driver or owner. In one embodiment, the Advanced AI-Assisted Vehicle may arrive at the valet drop-off location, the driver states “enable valet mode”, and the Advanced AI-Assisted Vehicle locks the trunk, and sets automatic limits including: (1) miles authorized, (2) region authorized (geo-fencing), (3) speed limits, (4) duration of approval, (5) authorized time windows (e.g., daytime only), and others. In one embodiment, valet mode includes security functionality that monitors the Advanced AI-Assisted Vehicle for prohibited activity such as smoking, drinking, or eating in the vehicle. Controller (100(1)) monitors the vehicle and uses the DNN pipeline to detect any prohibited activity. If the DNN pipeline detects prohibited activity, Controller (100(1)) sends a notification to UI (1000) which provides a visual and audio notification that the activity is prohibited and should immediately halt.

In one embodiment, the system uses a neural network to identify the valet or another member of the valet service, to allow the car to be retrieved when the owner is ready for it. Referring to FIG. 25, the system updates FACE ID database to include authorized valets. The update is typically received wirelessly from participating valet services, though wireless network (1100) and wireless modem (103). Authorized valets are then identified by Face ID (5002) DNN in the DNN pipeline.

In still other embodiments, the Advanced AI-Assisted Vehicle may include an additional factor of authentication or exterior authorized user/driver recognition by performing gesture recognition. According to embodiments, gesture recognition is not limited to hand gestures, but rather can be any single movement or a sequence of movements that may include hand gestures, eye blinks, head nods, and other forms of body movement. In one embodiment, a vehicle’s owner may unlock the vehicle by performing one or more pre-registered gestures (e.g., a “thumbs up”) upon approach and/or in front of pre-designated sensors or sensor regions. In another embodiment, a vehicle driver may start the vehicle’s ignition or turn on the vehicle’s onboard computing system(s) by performing a registered gesture inside the vehicle’s cabin.

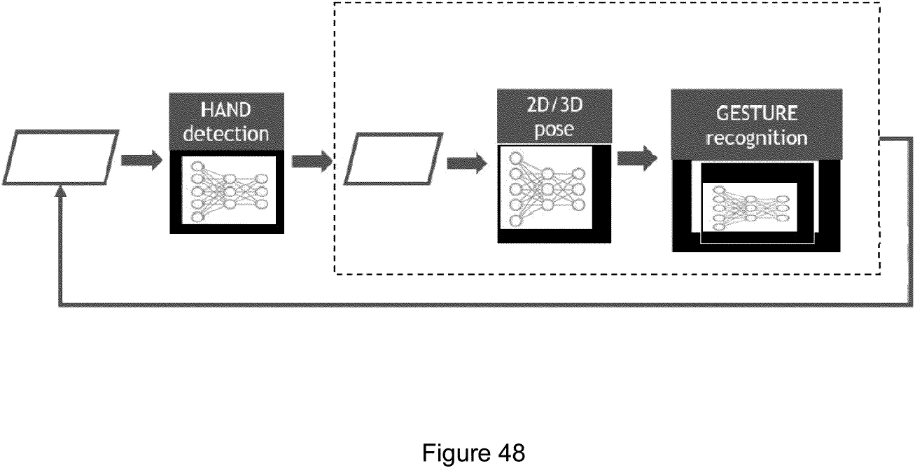

Gestures may be registered for different levels of authorization or even different operations. For example, a vehicle’s principal driver or owner may have a gesture that provides access to all levels of operation, whereas a temporary driver – such as a valet – may have an entirely separate gesture registered to him or her that provides access to driving operations, but not to unlock storage areas, turn on media devices, etc. As depicted in FIG. 48, the system may use one or more neural networks to identify the gesture of one or more persons as a second (or third) factor of authentication for accessing the interior and/or operation capabilities of the vehicle. For example and without limitation, a neural network may be used to detect a person’s hand from a set of images, while another neural network estimates a 2- dimensional and/or 3-dimensional pose of the hand. A final neural network can be used to perform the gesture recognition for estimated hand pose.

In another embodiment, even when the vehicle is parked, unoccupied, and powered-down, the vehicle enters a low-powered state, using a low-powered security controller. In this low-powered state, only exterior ultrasonic sensors are active, used as motion detectors to detect persons in the immediate vicinity of the vehicle. In the low-powered state, low-power control unit monitors the ultrasonic sensors to determine when a person is within one foot of the vehicle. If low-power security controller determines that a person is within one foot of the vehicle, the low-power security controller determines which cameras cover the area of activity, activates the camera, and begins recording images. Low-power security controller then instructs controller (100(1)) to power-up and process the images through the DNN pipeline for risk assessment module (6000) to determine the presence of any improper or unwanted attempt to enter or damage the vehicle. Risk assessment module (6000) can activate an audio alarm, send a text or notification to the vehicle’s owner with an image from the camera, and even send a notification to the authorities, identifying the vehicle’s location, state, and the nature of the security compromise. If the DNN pipeline and risk assessment module (6000) conclude that no security event is ongoing, the vehicle powers-down controller (100(1)) and camera and returns to the low-powered state.

In another embodiment, risk assessment module (6000) determines whether pedestrians outside the vehicle are in danger and provides appropriate warnings.

According to embodiments of the invention, the Advanced AI-Assisted Vehicle preferably has advanced sensing capabilities that it uses to assist departing travelers and other traffic participants. In embodiments, the Advanced AI-Assisted Vehicle provides external communications to assist third parties, including: (1) communication with pedestrians including at pedestrian crossings, (2) communication with other vehicles, including manual drivers and autonomous vehicles at intersections and including stop sign negotiations, and/or (3) communication with all other traffic participants of possible hazards.

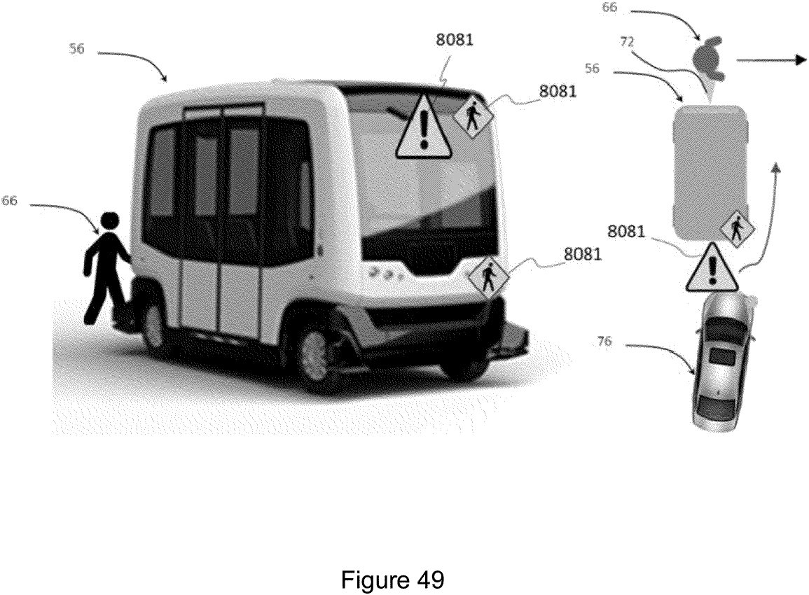

In various embodiments the Advanced AI-Assisted Vehicle improves road safety by communicating potential hazards to unaware traffic participants, thereby using the vehicle’s advanced detection capabilities to improve overall road safety. For example, one of the most dangerous conditions for bus-shuttle passengers is the time during which immediate departure or boarding occurs, when passengers outside the shuttle and other vehicles may be attempting to pass. In one embodiment, as illustrated in FIG. 49, shuttle uses its rear-facing camera to detect the presence of passenger (66) and its forward-facing camera to detect passing vehicle (76). Shuttle preferably notifies approaching vehicle (76) via flashing pedestrian warning signs (8081), indicating the presence of passenger and the side of the shuttle of the passenger. Similarly, shuttle preferably notifies passenger (66) of the hazard (76) via flashing “wait” signs (known to pedestrians) or approaching automobile warning signs. Shuttle preferably notifies passenger through speakers, audibly declaring a warning such as “WARNING-VEHICLE APPROACHING.” When the vehicle passes, shuttle may indicate “Walk to Curb” or other command that it is safe for the traveler to proceed.

In another embodiment, risk assessment module (6000) determines whether pedestrians outside the vehicle are providing traffic direction and/or vehicle assistance.

According to embodiments of the invention, the Advanced AI-Assisted Vehicle preferably has advanced sensing capabilities that it uses to perform vehicle control and navigation decisions based on the identified body poses of pedestrians and other persons (e.g., cyclists) sharing a common road or path or within a certain proximity or region of perception. In various embodiments, the Advanced AI-Assisted Vehicle provides (limited) control or direction of an Advanced AI-Assisted vehicle for external third parties, or adjusts control and navigation decisions based on detected body poses of identified and authorized entities. In embodiments, the process for performing control or navigation decisions includes: (1) identifying authorized third parties (e.g., crossing guards, toll booth operators, security officers, or law enforcement agents, etc.) or other external third parties where body gestures or poses can be observed (e.g., pedestrians, bicyclists, etc.), (2) identifying gestures or body poses from the third parties, (3) providing vehicle control and/or limited driver assistance based on identified gestures from authorized third parties. The amount of vehicle control can include, for example and without limitation, turning on one or more signal lights, turning on or off certain lights, approaching or reversing slowly, stopping or parking, etc. Information derived from a third party’s body poses or gestures that can assist an autonomous vehicle’s control and navigation can include, for example and without limitation, indications about the intended movement of the third party (e.g., signaling that the third party is making a left or right turn, stopping, or slowing), and indications about the likely movement of vehicles in a lane (e.g., based on a crossing guard’s pose and gestures).

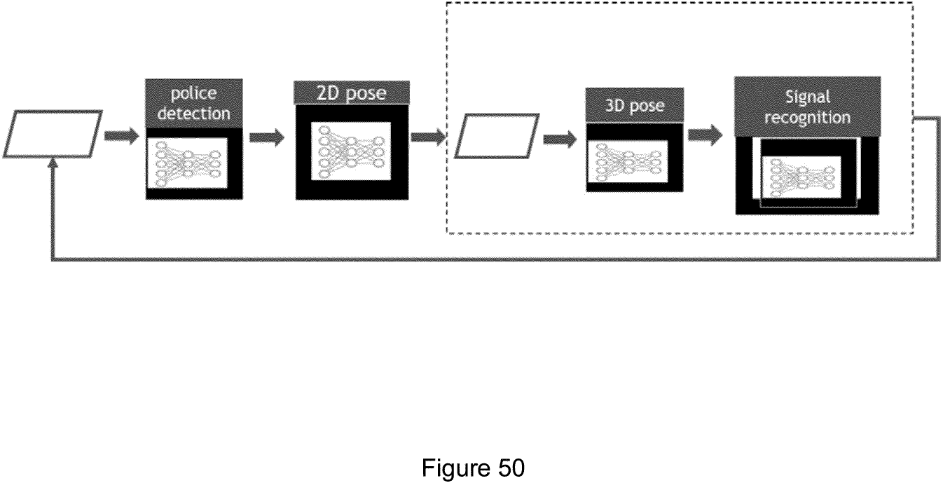

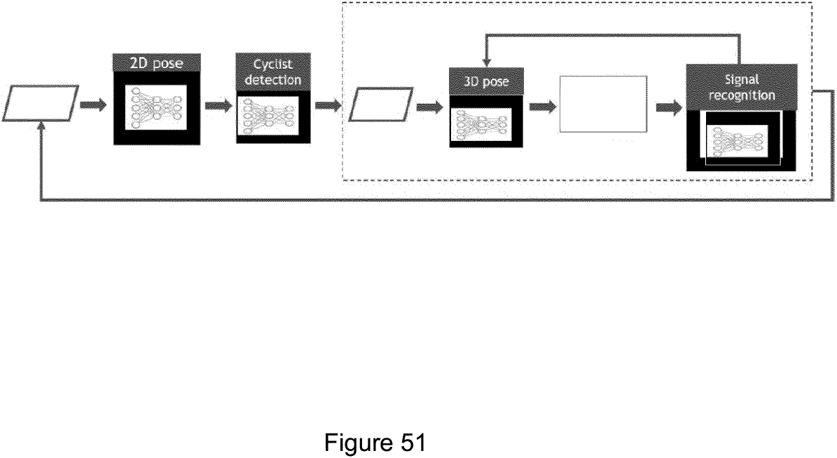

According to embodiments, body pose estimation can be performed using one or more neural networks. As depicted in FIG. 50, one or more neural networks may be used to identify an authorized external party and infer an initial 2-D pose. The output from the 2-D pose estimator may be used by one or more other neural networks in sequence to infer a 3-D pose, and a corresponding signal gesture. The signal gesture is then be mapped to a pre-registered control action or behavior of the vehicle and the action or behavior is then assessed to determine if the action or behavior is appropriate and safe for the vehicle, its passengers, and surrounding environment (including pedestrians, structures and objects, and the external signaling party). The action or behavior may be performed only if such an action or behavior is deemed appropriate and safe after the assessment. Another embodiment is depicted in FIG. 51, which presents an inferencing pipeline that is repeated in a loop during operation for identifying body pose and gestures of pedestrians and passengers of non-autonomous vehicles that includes a neural network for performing 2-dimensional pose estimation, a separate neural network for classifying the party (e.g., as a pedestrian or bicyclist), another neural network for performing 3-dimensional pose estimation, and a final neural network for performing the signal recognition based on the identified gesture.

It is always a challenge to visually notify a user, as it is unknown where the user is looking. Current solutions do not take gaze and head pose tracking into account for visual feedback. This invention tries to solve this problem. Head pose and gaze information from DNN (5003) and (5004) and is used to visually notify the user in the region where the user is looking.

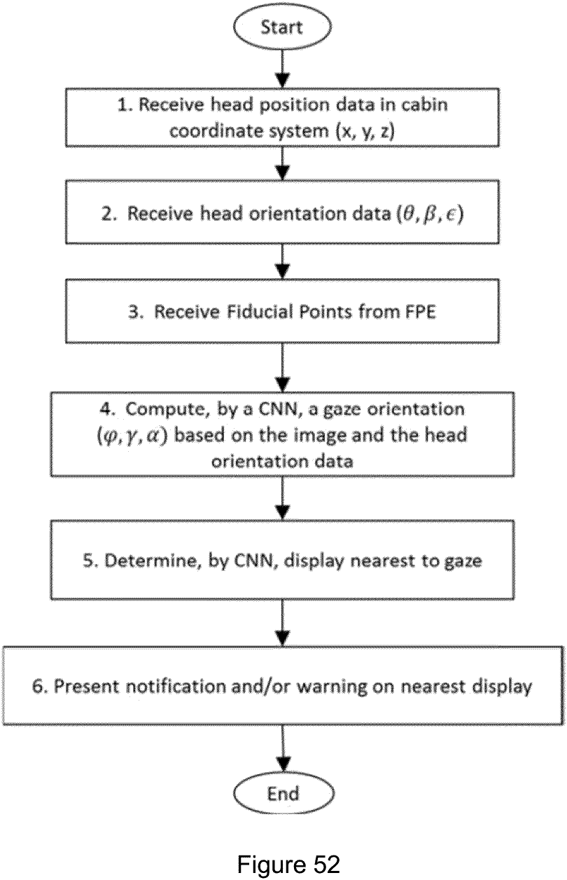

FIG. 52 illustrates the process. In steps (1)-(4), the system uses DNN pipeline to determine gaze. Another DNN uses that information to determine the nearest display. For example, in the vehicle illustrated in FIG. 23, the DNN would use gaze and head position to determine the display screen nearest to the driver’s gaze from among AV Status Panel (900), Master Display Screen (903), Secondary Display Screen (904), Surround Display Screen (901), and Communication Panel (902).

Driver may wish to regain control of vehicle after a period of autonomous driving. For example, in embodiments, driver can disengage the AV Mode by (1) applying Steering wheel torque above a threshold, (2) applying braking pedal action above a threshold, (3) applying accelerator pedal action beyond a threshold, and/or (4) pressing an AV Mode disengage button on the steering wheel. These commands are known and intuitive to drivers, as they are already associated with disengaging cruise control systems in conventional automobiles.

In other embodiments, the system acts as an AI-intelligent assistant to inform, advise, and assist the vehicle owner. In one embodiment, the vehicle’s state is recorded and uploaded into a cloud database, including the (1) location of the vehicle, (2) fuel or battery level, (3) time to service, (4) images of inside of cabin, (4) detected objects in car, (5) record of authorized users, and (6) state of vehicle tires, among others. This information is uploaded to the cloud periodically and uploaded before the car shuts down. Using a mobile or desktop application, a vehicle’s owner may select and view any of the vehicle’s information.

In one embodiment, the information is provided to a cloud server, which is configured to send notifications, reminders, and suggestions to the vehicle owner, including (1) reminders to charge or refuel the vehicle so that owner’s next-day commute is not delayed, (2) reminders and offers to schedule a service appointment, including proposed times for the appointment, and (3) notifications of items left in the vehicle, for example.

The owner can opt to make the vehicle information available to other drivers, whether in the same family, organization, or merely associates. The owner can activate this mode by voice-activated command, indicating that the vehicle’s information may be shared with other vehicles. For example, a parent can activate this feature in a vehicle driven by a teenager, allowing the parent to receive periodic updates and/or web access to information such as (1) location of the vehicle, (2) fuel or battery level, (3) time to service, (4) images of inside of cabin, (4) detected objects in car, (5) record of authorized users, and (6) state of vehicle tires, among others. This information may be presented to the parent on any of a mobile client, a desktop client, or a secondary display in another vehicle.

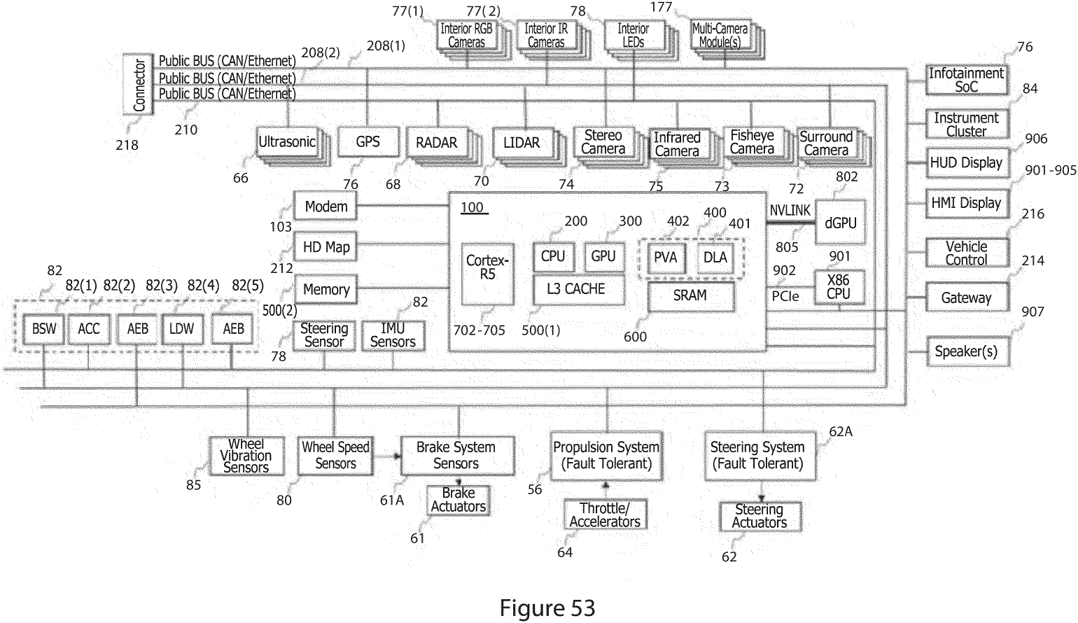

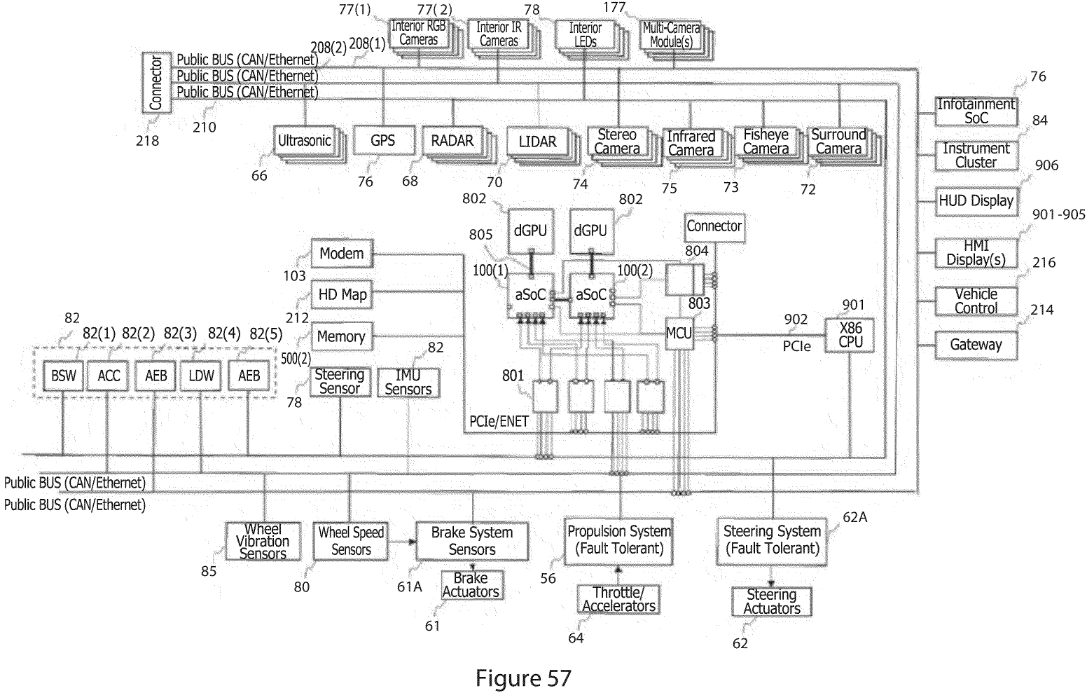

FIGS. 53 and 57 provide a more detailed depiction of another embodiment of the system, with a single Advanced SoC (100) used to conduct risk assessments, and provide the notifications, warnings, and autonomously control the vehicle, in whole or in part.

To monitor the outside of the vehicle, the embodiment of FIG. 53 includes one or more of the sensors described herein, including ultrasonic sensors (66), GPS (76), RADAR (68), LIDAR (70), stereo cameras (74), fisheye or wide-view cameras (73), infrared cameras (75), and surround cameras (72), positioned to provide 360-degree coverage around the vehicle.

To monitor the environment outside the vehicle, the embodiment of FIG. 53 includes one or more of the sensors and associated systems described herein, including one or more interior RGB cameras (77(1)), one or more interior IR cameras (77(2)), one or more interior LEDs (78), and interior Multi-Camera Modules (177).

To communicate with the driver, the embodiment of FIG. 53 includes one or more HMI displays (901-905) that may be arranged, for example, as illustrated in FIG. 23, as well as an optional heads-up display (906). The embodiment of FIG. 53 further includes one or more speakers (907).

In a first exemplary embodiment, shown in FIG. 53, two Advanced SoC (100(1) and 100(2)) are combined in a single vehicle. The first Advanced SoC (100(1)) is used to provide for autonomous driving functionality, executing an autonomous vehicle (AV) software stack to perform autonomous or semi-autonomous driving functionality. The first Advanced SoC (100(1)) may be the SoC described, for example, in U.S. Application No. 62/584,549, incorporated by reference. As described more fully in U.S. Application No. 62/584,549, advanced SoC (100) preferably includes CPU complex (200), GPU complex (300), L3 Cache connected to CPU and GPU complex, Hardware Acceleration Complex (400) including a PVA (402) and DLA (401), and Additional Embedded Processors, including one or more of Cortex R5 processors (702)-(705). The Advanced SoC (100) is connected to the various sensors and sub-systems (e.g., a fault operable/fault-tolerant braking system (61A) and a fault-operable/fault-tolerant steering system (62A)) to provide functional safety, again, as described in U.S. Application No. 62/584,549.

The second Advanced SoC (100(2)) may be another instance of the SoC described in U.S. Application No. 62/584,549. The second Advanced SoC (100(2)) is used primarily to conduct risk assessments, and provide the notifications, warnings. The Advanced SoC (100(2)) executes a “Drive IX” software stack to conduct risk assessments, and provide the notifications, warnings. The second Advanced SoC (100(2)) is also a fail-safe or redundant SoC that may be used to provide for autonomous driving functionality, executing a “Drive AV” software stack to perform autonomous or semi-autonomous driving functionality. The use of multiple Advance SoCs provide functional safety is described more fully in U.S. Application No. 62/584,549 and U.S. Application No. 62/524,283. As shown in FIG. 53, the two Advanced SoC (100(1) and 100(2)) are connected using a high-speed interconnect, such as PCIe.

In one embodiment, Advanced SoC’s CCPLEX (200) and one or more of the GPU complex (300), or hardware accelerators (401), (402) independently execute one or more DNNs to perform risk identifications, risk assessments, and provide the notifications, warnings, and autonomously control the vehicle. For example, GPU complex (300) may execute one, or all, of the DNNs in a DNN pipeline, such as the pipeline illustrated in FIG. 25. GPU complex (300) may execute a DNN for face detection (5001), a DNN (5003) trained to identify the pose of a head and output yaw, pitch, and roll angles, a DNN trained to estimate fiducial points (50011), a DNN trained to identify known individuals from face images (5002), a DNN trained to detect eye openness (5005), a DNN trained to perform lip reading (5006), and a DNN trained for gaze detection (5004), and DNNs trained to detect gestures of the driver and/or passengers (5008, 5009) such as a DNN to detect passenger conflict (5008) (preferred in vehicles such as taxis, buses, and shuttles) and driver distress (5009). GPU complex (300) may execute the DNNs in sequence or may execute two or more DNNs simultaneously. Alternatively, GPU complex (300) may execute one or more of the DNNs, while hardware accelerator PVA (402) may execute a computer vision algorithm to identify the presence of dangerous or illegal objects, such as a firearm.

In embodiments with a deep learning accelerator (401) the accelerator (401) may be used to execute one or more of the DNNs in the pipelines. Similarly, discrete GPU (802), when present, may also execute one or more of the DNNs in the pipelines.

The risk assessment module (6000) may execute on Advanced SoC’s CCPLEX (200) or alternatively, on a discrete CPU (901), such as an X86 CPU, when present. When risk assessment module (6000) commands, the advanced SoC (100) in the embodiment of FIG. 53 performs autonomous vehicle functions, using DNNs executing on the GPU complex (300), discrete GPU (802), or deep learning accelerator (401). In one embodiment, advanced SoC (100) may operate as described in U.S. Application No. 62/584,549. For example, GPU complex (300) may execute a neural network to perform an object detection functionality using input information from a stereo camera, while hardware accelerator PVA (402) may execute a computer vision algorithm to identify the same objects from a monocular camera or infrared camera. The system may also include one or more ADAS sub-systems (28), providing redundancy and enhancing functional safety, including BSW, ACC, AEB, and LDW systems. The system may optionally include a discrete GPU, dGPU (802), coupled to the Advanced SoC through a high-speed interconnect such as, without limitation NVLINK (805). dGPU (802) can provide additional AI functionality, execute redundant or different neural networks, and even train and/or update neural networks based on input from the system’s sensors. The system may also optionally include a discrete CPU (901), such as an X86 processor, connected to the Advanced SoC (100) through a high-speed interconnect such as, without limitation, PCIe (902). Discrete CPU (901) may be used to perform a variety of functions, including arbitrating potentially inconsistent results between ADAS sensors (28) and Advanced SoC (100), and/or monitoring the status and health of vehicle control (216) and infotainment system (76).

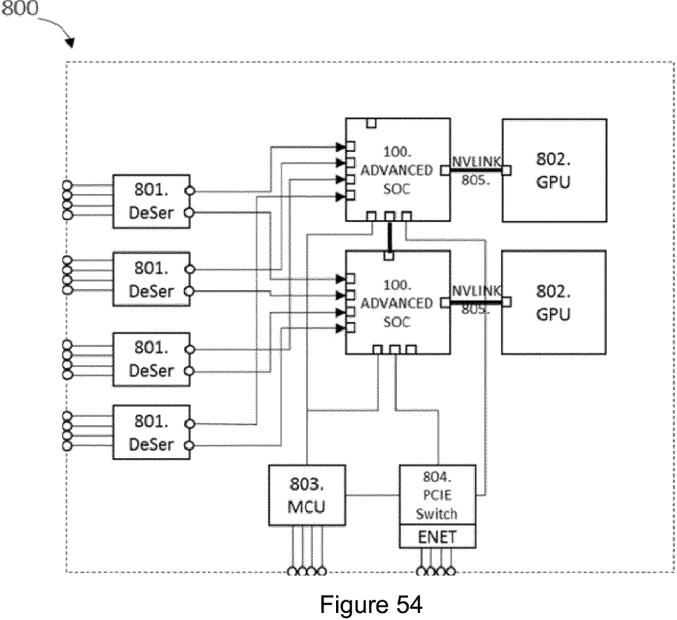

In one embodiment, a plurality of the Advanced SoCs shown in U.S. Application No. 62/584,549, incorporated by reference, are included in an overall system platform (800) for autonomous vehicles, shown in schematic form in FIG. 54. FIG. 54 shows two Advanced SoCs (100) connected by a high-speed interconnect (805) to discrete GPUs. The high-speed interconnect (805) is preferably NVIDIA’s NVLINK technology.

As illustrated in FIG. 54, the Advanced SoCs (100) are each connected to a Microcontroller (“MCU”) (803). MCU may comprise an SoC, stand-alone ASIC, or another processor. Commercially-available MCUs include microcontrollers from NXP or Aurix, such as, for example, a TC297 MSU or Infineon’s TC3X7 ADAS (TC397 ADAS) AURIXTM 2G Controller in LFBGA-292_ADAS Package, including the Infineon Aurix 397 (SAK-TC397XE-256F300S-AA). In a typical embodiment, the MCU is designed for an ASIL D functional safety level.

The MCU (803) operates as a master controller for the system. It can reset the two Advanced SoCs (100), switch the display between the two Advanced SoCs, and control the camera power. The MCU and the Advanced SoCs are connected through a PCIE Switch (804). Commercially-available PCIE switches include the MicroSemi PM8534 and/or the MicroSemi PM8533, though others may be used.

The Advanced SoCs (100) and dGPUs (802) may use deep neural networks to perform some, or all, of the high-level functions necessary for autonomous vehicle control. As noted above, the GPU complex (300) in each Advanced SoC is preferably configured to execute any number of trained neural networks, including CNNs, DNNs, and any other type of network, to perform the necessary functions for autonomous driving, including object detection and free space detection. GPU complex (300) is further configured to run trained neural networks to perform any AI function desired for vehicle control, vehicle management, or safety, including the functions of perception, planning and control. The perception function uses sensor input to produce a world model preferably comprising an occupancy grid, planning takes the world model and produces the best plan, and control takes the plan and implements it. These steps are continuously iterated.

Each Advanced SoC may offload some, or all, of these tasks to the discrete GPUs (802). The dGPUs (802) may perform redundant operation of one or more networks running on the GPU clusters on the Advanced SoCs, enhancing functional safety. Alternatively, the dGPUs (802) may run additional neural networks to perform any AI function desired for vehicle control, vehicle management, or safety. In one embodiment, dGPU (802) may be used to train a network, or to run a shadow network different from the network run on GPU cluster (300), providing further functional safety.

In the example shown, components (100), (802), (803), are mounted to a common printed circuit board and disposed within the same enclosure or housing, thus providing a “one-box” controller solution. The one-box computer solution preferably includes a system for efficiently cooling the processors and circuit board. In one embodiment, cooling system includes an active hybrid heat transport module adapted to be integrated with a fansink. In this embodiment, fansink includes, without limitation, a fan, walls, and a bottom plate. In one embodiment, system also includes a heat sink lid, which, among other things, prevents particles and other contaminants from entering fan and air blown from fan from escaping system. The Heat sink lid, together with walls and bottom plate of fansink, define a plurality of air channels. The hybrid heat transport module comprises both a fluid channel and an air channel adapted for transporting heat. The hybrid heat transport module and the fansink may be used alone or in combination to dissipate heat from the processor.

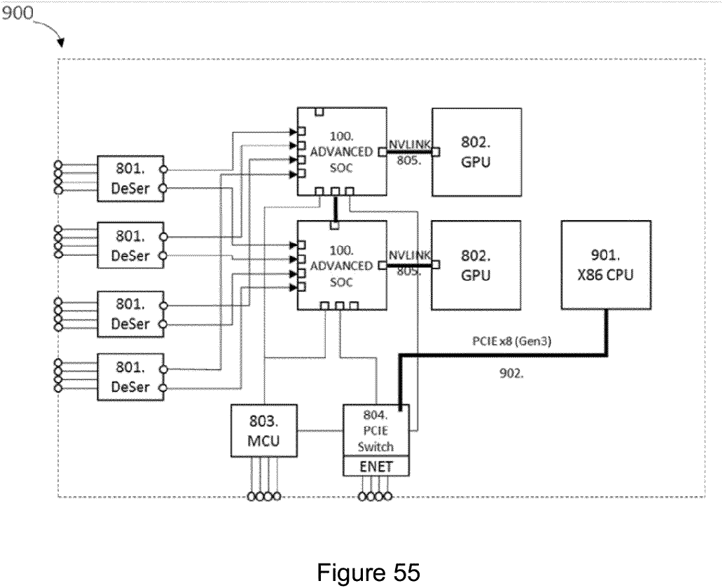

FIG. 55, illustrates a further embodiment of the platform architecture, (900). The embodiment is identical to the embodiment shown in FIG. 54, with the addition of an X86 CPU (901), connected to the PCIE Switch (804) through a PCIE x8 Bus, (902).

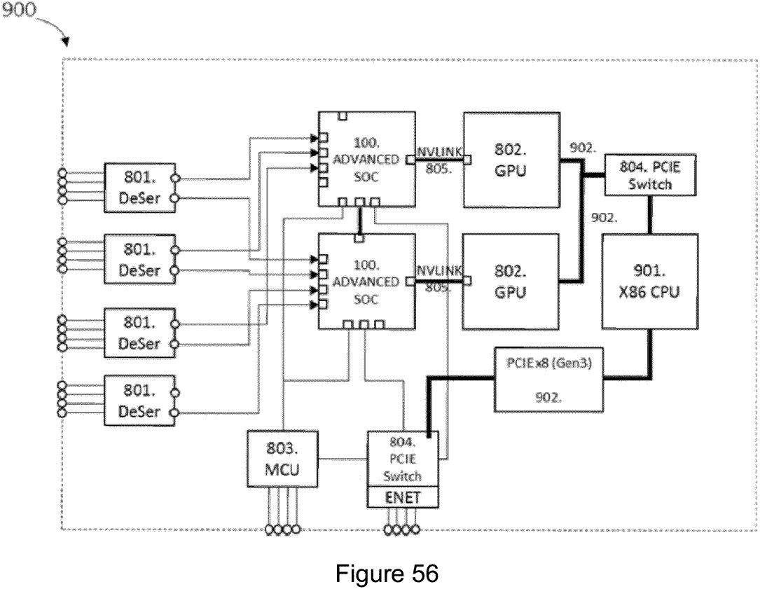

FIG. 56 illustrates another embodiment of the platform architecture, (900). The embodiment is identical to the embodiment shown in FIG. 55, with the addition of a second PCIE Switch (804) that allows the X86 CPU (901) to communicate with the GPUs (802) through a PCIE x8 Bus, (902).

Additional platform embodiments are described in co-pending Application No. 62/584,549, (Attorney Docket No. 17-SC-0262-US01), filed Nov. 10, 2017. In determining the safest route in the presence of pedestrians, cross-traffic, and other obstacles, self-driving shuttle (50) may employ one or more of the techniques described in co-pending Application No. 62/625,351, (Attorney Docket No. 18-RE-0026-US01) filed Feb. 2, 2018, and Application No. 62/628,831, (Attorney Docket No. 18-RE-0038US01), filed Feb. 9, 2018. Furthermore, Advanced AI-assisted vehicle (50) may employ the turning and navigation techniques described in Application No. 62/614,466, (Attorney Docket No. 17-SC-0222-US01), filed Jan. 7, 2018.

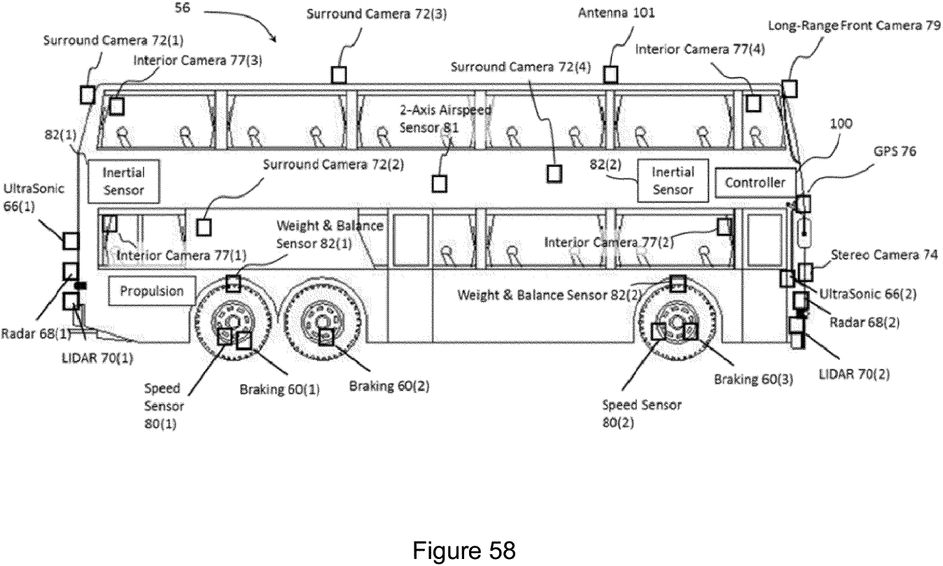

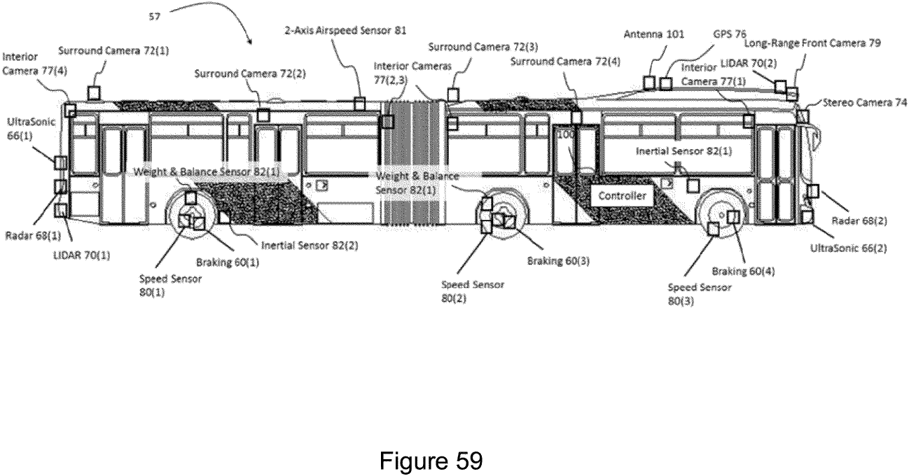

“Advanced AI-assisted vehicle” as used herein includes any vehicle suitable for the present invention, including vans, buses, double-decker buses, articulated buses, robo-taxis, sedans, limousines, and any other vehicle able to be adapted for autonomous on-demand or ride-sharing service. For example, FIG. 58 below, illustrates a self-driving two-level bus (56). FIG. 59 below, illustrates a self-driving articulated bus (57).

While aspects of the invention have been described in terms of what is presently considered to include the most practical and preferred embodiments, it is to be understood that the invention is not to be limited to the disclosed embodiments. For example, unless expressly stated, the invention is not limited to any type or number of sensors; any number or type of sensors falling within the language of the claims may be used. Moreover, as an example, while the discussion above has been presented using NVIDIA hardware as an example, any type or number of processor(s) can be used. On the contrary, is intended to cover various modifications and equivalent arrangements included within the spirit and scope of the appended claims.

Aspects of the various embodiments can be implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP or FTP. The network can be, for example, a local area network, a wide-area network, a virtual private network, the Internet, an intranet, an extranet, a public switched telephone network, an infrared network, a wireless network and any combination thereof. In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Python, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. (canceled)

2. A method comprising:
receiving sensor data obtained using one or more sensors of a machine, the sensor data representative of a pedestrian located outside of the machine;
determining, using one or more neural networks and based at least on the sensor data, a gesture being made by the pedestrian; and
causing, based at least on the gesture, the machine to perform one or more operations.

3. The method of claim 2, further comprising:
determining, based at least on the gesture, an intent associated with the pedestrian,
wherein the causing the machine to perform the one or more operations is based at least on the intent.

4. The method of claim 3, wherein the intent is associated with one or more of:
causing the machine to continue navigating;
causing the machine to stop; or
causing the machine to navigate to a position associated with the pedestrian.

5. The method of claim 2, further comprising:
determining, using the one or more neural networks and based at least on the sensor data, that the pedestrian includes personnel affiliated with one or more of law enforcement, fire protection, emergency services, or a crossing guard,
wherein the causing the machine to perform the one or more operations is further based at least on the pedestrian including the personnel corresponding to the one or more of law enforcement, fire protection, emergency services,, or a crossing guard.

6. The method of claim 2, further comprising:
determining, using the one or more neural networks and based at least on the sensor data, that the pedestrian is associated with a vehicle detected in an environment corresponding to the machine and represented at least partially in the sensor data,
wherein the causing the machine to perform the one or more operations is further based at least on the pedestrian being associated with the vehicle.

7. The method of claim 2, further comprising causing, using one or more output devices associated with the machine, an alert associated with the gesture being made by the pedestrian.

8. The method of claim 2, further comprising:
determining, based at least on second sensor data generated using one or more second sensors of the machine, a gaze direction associated with a driver of the machine; and
determining, based at least on the gaze direction, that the pedestrian is located outside of a field-of-view (FOV) of the driver,
wherein the causing the machine to perform the one or more operations is further based at least on the pedestrian being located outside of the FOV of the driver.

9. The method of claim 2, wherein the gesture is associated with at least one of:
a motion of a portion of the pedestrian; or
a motion of an item that is in possession of the pedestrian.

10. A system comprising:
one or more processing units to:
receive sensor data generated using one or more exterior sensors of a machine, the sensor data representative of a pedestrian;
determine, using one or more neural networks and based at least on the sensor data, a gesture being made by the pedestrian; and
cause, based at least on the gesture, the machine to perform one or more operations.

11. The system of claim 10, wherein the one or more processing units are further to:
determine, based at least on the gesture, an intent associated with the pedestrian,
wherein the machine is caused to perform the one or more operations based at least on the intent.

12. The system of claim 11, wherein the intent is associated with one or more of:
causing the machine to continue navigating;
causing the machine to stop; or
causing the machine to navigate to a position associated with the pedestrian.

13. The system of claim 10, wherein the one or more processing units are further to:
determine, using the one or more neural networks and based at least on the sensor data, that the pedestrian includes personnel affiliated with one or more of law enforcement, fire protection, emergency services, or a crossing guard,
wherein the machine is further caused to perform the one or more operations based at least on the pedestrian including personnel affiliated with the one or more of law enforcement, fire protection, emergency services, or the crossing guard.

14. The system of claim 10, wherein the one or more processing units are further to:
determine, using the one or more neural networks and based at least on the sensor data, that the pedestrian is associated with a vehicle detected in an environment corresponding to the machine and represented at least partially in the sensor data,
wherein the machine is further caused to perform the one or more operations based at least on the pedestrian being associated with the vehicle.

15. The system of claim 10, wherein the one or more processing units are further to cause, using one or more output devices associated with the machine, an alert associated with the gesture being made by the pedestrian.

16. The system of claim 10, wherein the one or more processing units are further to:
determine, based at least on second sensor data generated using one or more interior sensors of the machine, a gaze direction associated with a driver of the machine; and
determine, based at least on the gaze direction, that the pedestrian is located outside of a field-of-view (FOV) of the driver,
wherein the machine is further caused to perform the one or more operations based at least on the pedestrian being located outside of the FOV of the driver.

17. The system of claim 10, wherein the gesture is associated with at least one of:
a motion of a portion of the pedestrian; or
a motion of an item that is in possession of the pedestrian.

18. The system of claim 10, wherein the system is comprised in at least one of:
a control system for an autonomous or semi-autonomous machine;
a perception system for an autonomous or semi-autonomous machine;
a system for performing deep learning operations;
a system for generating synthetic data;
a system incorporating one or more virtual machines (VMs);
a system implemented at least partially in a data center; or
a system implemented at least partially using cloud computing resources.

19. A processor comprising:
one or more processing units to cause, based at least on a gesture made by a pedestrian located outside of a machine, the machine to perform one or more operations, wherein the gesture is determined using one or more neural networks and based at least on sensor data generated using one or more exterior sensors associated with the machine.

20. The processor of claim 19, wherein the one or more processing units are further to:
determine, based at least on the gesture, an intent associated with the pedestrian,
wherein the machine is caused to perform the one or more operations based at least on the intent.

21. The processor of claim 19, wherein the processor is comprised in at least one of:
a control system for an autonomous or semi-autonomous machine;
a perception system for an autonomous or semi-autonomous machine;
a system for performing deep learning operations;
a system for generating synthetic data;
a system incorporating one or more virtual machines (VMs);
a system implemented at least partially in a data center; or
a system implemented at least partially using cloud computing resources.
